(19) United States
(12) Patent Application Publication
(10) Pub. No.: US 2025/0385911 A1
(43) Pub. Date: Dec. 18, 2025

(54) NETWORK BASED ID FOR USER TRACKING

(71) Applicant: BCE INC., Verdun (CA)

(72) Inventors: Jefferson OR, Markham (CA); Matt ALEXANDER, Oakville (CA); Jeffrey PAK, Markham (CA); Sindhuja GUTHA, Etobicoke (CA); Omar DAUDI, Milton (CA)

(21) Appl. No.: 19/235,134

(22) Filed: Jun. 11, 2025

Related U.S. Application Data
(60) Provisional application No. 63/659,038, filed on Jun. 12, 2024.

(51) Int. Cl. H04L 9/40

(52) U.S. Cl. CPC H04L 63/0876

(57) ABSTRACT

Systems and methods for identifying a user with a publisher specific network based identifier. The method comprising: receiving a request for a unique user identifier associated with a user device that accesses the publisher; parsing a database for an existing user identifier associated with the user device for the publisher, the database storing a plurality of existing user identifiers associated with user devices for respective publishers; when the existing user identifier is found, returning the existing user identifier associated with the user device; otherwise: generating the unique user identifier; returning the unique user identifier; and storing the unique user identifier in the database in association with the user device and the publisher.

### CROSS-REFERENCE TO RELATED APPLICATIONS

This application claims priority to U.S. Provisional Patent Application No. 63/659,038, filed on Jun. 12, 2024, the entire contents of which are incorporated herein by reference for all purposes.

### TECHNICAL FIELD

The present disclosure relates to network based IDs for user tracking and in particular to anonymous and publisher specific network based IDs for tracking users that are reliable over time.

### BACKGROUND

As the world moves towards a digital age, significant value is placed on the ability to identify users. Particularly, there is significant interest by publishers to track and monitor the activities of users online, which may be useful in analyzing the habits and interests of these users for various purposes. Traditionally, users can be tracked over a network using user identifiers such as cookies or mobile ad IDs (MAIDs).

However, these methods were ripe with abuse as data tracking companies have been harvesting and selling user data without any control provided by the users. As user expectations for privacy have increased, along with the fact that in some cases, laws have been passed to protect user privacy, larger tech companies are pushing to eliminate the use of existing methods such as cookies. Moreover, these methods can be lacking in many aspects. For example, the user may not be consistently identified across different platforms or over time. These methods may also lack the ability to track households, provide verification for fraud prevention, or allow users to control their own identification preferences.

Further, certain product developers have implemented a number of changes that limit how user identifiers can be used on its hardware and software products. These changes can significantly impact the ability for publishers to identify and track user activity. As a result, it may be difficult for publishers and other entities to provide personalized and improved experience to the users, to better reach the users and generate awareness for their products and content, and determine the user's reception to the publisher content.

At the same time, any methods for user identification should address privacy and security concern of the users, ensuring a consistent and personalised user experience over time and across different devices while providing the users with authority and control over the data that they share.

Accordingly, systems and methods for tracking users with anonymous and publisher specific network based IDs for that are reliable over time remains highly desirable.

### SUMMARY

In accordance with one aspect of the present disclosure, a method of establishing a connection between a user device and a publisher is disclosed, comprising: receiving a request for a unique user identifier associated with a user device that accesses the publisher; parsing a database for an existing user identifier associated with the user device for the publisher, the database storing a plurality of existing user identifiers associated with user devices for respective publishers; when the existing user identifier is found, returning the existing user identifier associated with the user device specific; and when there is no existing user identifier: generating the unique user identifier associated with the user device specific to the publisher;

returning the unique user identifier; and storing the unique user identifier in the database in association with the user device and the publisher.

In some aspects, the request for the unique user identifier associated with the user device is received from the user device in response to the user device accessing a webpage by the publisher.

In some aspects, the request is an asynchronous call.

In some aspects, the request comprises information identifying the user device and publisher information.

In some aspects, the method further comprises: receiving an authentication request for receiving the unique user identifier from the publisher.

In some aspects, the authentication request comprises publisher information.

In some aspects, the method further comprises: processing the authentication request.

In some aspects, processing the authentication request comprises: determining if the publisher is authorized to receive the unique user identifier; and authorizing the publisher to receive the unique user identifier.

In some aspects, the request comprises a public IP of the user device, an identifier of the publisher, and a publisher authorization token.

In some aspects, the device further comprises: providing instructions for retrieving the unique user identifier; and receiving a retrieval request for the unique user identifier.

In some aspects, the instructions and retrieval request is an asynchronous call.

In some aspects, the retrieval request comprises a source IP of the user device.

In some aspects, the instructions are provided to the publisher and the retrieval request is received from the user device.

In some aspects, the request is received from the publisher and the unique user identifier is returned to the user device.

In some aspects, the user device is identified by an IP address.

In some aspects, a mapping of IP address to subscriber information is performed.

In some aspects, the user device is a mobile device or a household modem.

In some aspects, the method further comprises: verifying a consent status of the user device; the unique identifier only returned if the user device consents to the return of the unique identifier.

In some aspects, the request for the unique user identifier associated with the user device is received from the user device in response to the user device accessing content of the publisher, and the publisher directs the user device to transmit the request for the unique user identifier.

In some aspects, the request for the unique user identifier is an asynchronous call comprising a unique user device identifier and a unique publisher identifier; and the unique user identifier is returned to the user device via a response to the asynchronous call.

In some aspects, the method further comprises: authenticating the publisher prior to returning the unique user identifier, the publisher authenticated based on the unique publisher identifier.

In some aspects, the user device is identified by a source IP associated with a subscriber of a network provider; the unique user identifier corresponds to the subscriber and is parsed from the database or generated based on subscriber information of the subscriber and/or the source IP.

In some aspects, the method further comprises: determining a connection protocol of the request for the unique user identifier, the connection protocol being IPv4 or IPv6.

In some aspects, the method further comprises: extracting a source IP of the user device for parsing the database from the request for the unique user identifier, the request for the unique user identifier being an IPV6 request; and the source IP corresponds to the unique user identifier.

In some aspects, the request for the unique user identifier is an IPv4 request, the method further comprises: transmitting instructions for retrieving the unique user identifier to the user device; receiving a retrieval request corresponding to the instructions for the unique user identifier from the user device; and performing the parsing of the database based on the retrieval request.

In some aspects, the method further comprises: determining a source IP of the user device from the retrieval request for parsing the database, the source

IP corresponds to the unique user identifier; the instructions is an asynchronous call comprising a redirection URL, and the retrieval request is an asynchronous call corresponding to the redirection URL for determining the source IP of the user device.

In some aspects, the instructions are transmitted to the user device, and the retrieval request is received from the user device.

In some aspects, the method further comprises: receiving a request for providing the request for the unique user identifier to the user device in response to the user accessing content of the publisher; verifying the request for providing the request for the unique user identifier to the user device; and providing the user device with the request for the unique user identifier to the user device.

In some aspects, the request for providing the request for the unique user identifier to the user device is received from the publisher; the request for the unique user identifier is provided to the user device via the publisher; and the request for the unique user identifier is received from the user device.

In some aspects, the method further comprises: requests from the user device are formulated as API requests and responses to the user device are formulated as API responses; an ID finder module implemented on a private server is configured to process the API requests and API responses and communicate with an API module; the API module is configured to parse the database and process the API requests and API responses from the ID finder module; and the database and the API module are implemented on a public server.

In some aspects, the method further comprises: verifying a consent status of the user device for the returning of the unique user identifier; the returning of the unique identifier dependent on the consent status.

In some aspects, the user device has not yet provided the consent status; the method further comprises: prompting the user device to provide the consent status.

In some aspects, the method further comprises: determining a connection type of the user device for accessing the publisher; the unique user identifier is a set of unique identifiers comprising: a first identifier corresponding to the user device and the publisher; and a second identifier corresponding to the connection type of the user device and the publisher; and the connection type is a mobile network connection or a wireline network connection.

In accordance with another aspect of the present disclosure, a method of monitoring user activity is disclosed, comprising: receiving a request from a user device to access content by a publisher; redirecting the user device to retrieve a unique user identifier associated with the user device for the publisher; receiving the unique user identifier from the user device; monitoring user interactions by the user device with the publisher content; and storing the user interactions in association with the user identifier.

In some aspects, the content is a webpage by the publisher.

In some aspects, the method further comprises: requesting authentication for receiving the unique user identifier.

In some aspects, the method further comprises: requesting instructions for redirecting the user device.

In some aspects, the request for instructions the comprises a public IP of the user device, an identifier of the publisher, a publisher authorization token, or a combination thereof.

In some aspects, the instructions is an asynchronous call.

In some aspects, the method further comprises receiving an IP address of the user device.

In some aspects, the unique user identifier is received from an asynchronous call.

In some aspects, the user device is a mobile device or a household modem.

In accordance with another aspect of the present disclosure, a system is provided, the system comprising one or more processors configured to perform the method of any one of the above aspects.

In accordance with another aspect of the present disclosure, a non-transitory computer-readable medium having computer readable instructions stored thereon is provided, which, when executed by one or more processors, configure the one or more processors to perform the method of any one of the above aspects.

### BRIEF DESCRIPTION OF THE DRAWINGS

Further features and advantages of the present disclosure will become apparent from the following detailed description, taken in combination with the appended drawings, in which:

FIG. 1 shows a representation of a system for identifying users with a publisher specific network based ID, according to an example embodiment;

FIG. 2a shows a system for identifying users with a publisher specific network based ID, according to an example embodiment;

FIG. 2b shows the system of FIG. 2a including the flow of different data, according to an example embodiment;

FIG. 2c shows another system for identifying users with a publisher specific network based ID, according to an example embodiment;

FIGS. 3a to 3c show processes of obtaining a publisher specific network based ID, according to example embodiments;

FIGS. 4a and 4b show methods of providing a publisher specific network based ID to publishers, according an example embodiments;

FIG. 5 shows a method of identifying a user using a publisher specific network based ID, according to an example embodiment;

FIG. 6 shows a system for providing personalized content to users using publisher specific network based IDs, according to an example embodiment; and

FIG. 7 shows exemplary responses for requests for publisher specific network based IDs, according to an example embodiment.

It will be noted that throughout the appended drawings, like features are identified by like reference numerals.

### DETAILED DESCRIPTION

The present disclosure relates to systems and methods pertaining to publisher specific network based IDs for tracking users. The systems and methods provide a robust solution that may preserve user choices (e.g., preferences and customization in privacy options), enable various benefits to publishers, and ensure protections to the users. In particular, an improved digital identifier, namely an anonymous publisher specific network based IDs for tracking users, is disclosed. Notably, wireline internet and mobile internet carriers have the ability to identify the subscribers of their networks, by utilizing this capability, it is possible to provide a robust identity solution for publishers to use for the purposes of tracking analytics such as web visits, frequency of visits and many other important key performance indicators. In particular, customer information and metrics critical to web publishers as well as protections to user information without negatively impacting the user experience or expectations with respect to the speed of internet navigation may be achieved by means of the present disclosure. In a sense, the publisher specific network based IDs disclosed herein may be considered to be a smart identifier or intelligent identifier as they are fixed across different platforms and invariant over time while being specific to a particular device and publisher, as will be made apparent by the present disclosure. The systems and methods discussed herein can also provide re-targeting services where carriers act as the post office to facilitate an anonymous re-targeting to the user outside the publishers view.

The systems and methods of the present disclosure may utilize a cloud-based asynchronous architecture configured to make various asynchronous HTTP calls that would ultimately provide a publisher with a network based ID for identifying a user. The systems and methods of the present disclosure would not impact the latency of the browsing transaction by the user, with around 110 and 170 milliseconds elapsing between the initial call of user equipment request to the delivery of the network based ID to the publisher measures between. As such, users' browsing experience is not adversely affected. Further, scalability may be achieved as load testing of 11,000 transactions per second into a staging environment showed healthy CPU usage, utilizing less than half of available resources. That is, user experience and system performance would not be degraded through the implementation of the disclosed methods and systems.

According to a broad aspect of the present disclosure, a user may visit a participating publisher's site and be quickly redirected to a private network. An IP mapping to a publisher specific network based ID is performed, where the user equipment is redirected to visit the publisher's site with the publisher specific network based ID assigned. This design can help ensure the privacy of a user's online behaviour. As the ID can be specific to a publisher and the user equipment and is in a relationship not otherwise utilized, this information is not useful to other publishers.

Advantageously, the publisher specific network based ID may be a unique individual ID or a household ID, which may be provided to a publisher indicating a particular device (user) or a group of users that share the same network (e.g., connected to the same modern) to better identify/track users. By providing two types of IDs, the publishers may be able to better understand traffic patterns and household (e.g., group of users) level information. Contrary to MAIDs or cookies, these publisher specific network based IDs may be consistent across different properties (e.g., consistent whether a content is accessed through the web or an app). Further, as the publisher specific network based ID can be stored in the cloud and may be restored with simple API calls, they can be reliable over time. That is, these IDs are consistent when the current device is replaced with a new one or when a factory reset is performed. By tracking the IDs, the publishers may be able to monitor and analyze the interests of the user to both provide content that is better tailored to the user, analyze the behaviours/habits/responses of the user, and monitor the changes in user activity over time.

The systems and methods of the present disclosure may be implemented in a straightforward fashion. A participating publisher may be provided with some degree of access to the system of the present disclosure. For example, API access (for providing the publisher specific network based ID), documentation, code snippets, and consent requirements may be provided. The publisher may integrate the API for providing the publisher specific network based ID into their app or website. By further incorporating consent requirements (for example, similar to opt-in and opt-out for General Data Protection Regulation cookies consent), it may be possible to better protect user privacy and ensure that their privacy choices are respected. It may also be possible to conduct ID linking between publishers for clean room matching, cross site targeting and data onboarding.

In particular, the present disclosure may provide systems and methods for establishing a connection between a user device and a publisher by providing the publisher with a publisher specific network based ID. Specifically, a publisher may request a publisher specific network based ID for identifying an user accessing their content. The publisher may be authenticated and if authorization is granted, an URL for retrieving the publisher specific network based ID can be provided to the publisher. Upon receiving an asynchronous call by the user equipment using the URL, an ID lookup process is performed in which a database storing user identifiers associated with various user equipment is parsed to find the publisher specific network based ID that corresponds to the user equipment. If a corresponding ID is not found, a new publisher specific network based ID is generated for the user and stored in the database. The publisher specific network based ID is then returned and assigned to the user device as it browse the publisher content.

The present disclosure may also provide systems and methods for monitoring user activity. Specifically, a user equipment may request content from a publisher by, for example, opening up an app or accessing a website associated with the publisher. The publisher may request a publisher specific network based ID for identifying the user accessing their content. In response, an URL for retrieving the publisher specific network based ID may be received. The publisher can embed the URL in the content accessed by the user equipment which would redirect the user equipment to retrieve the publisher specific network based ID. The publisher can then receive the publisher specific network based ID assigned to the user equipment. The publisher can track the activities of the user by monitoring the publisher specific network based ID and storing any activities/interactions associated with the publisher specific network based ID.

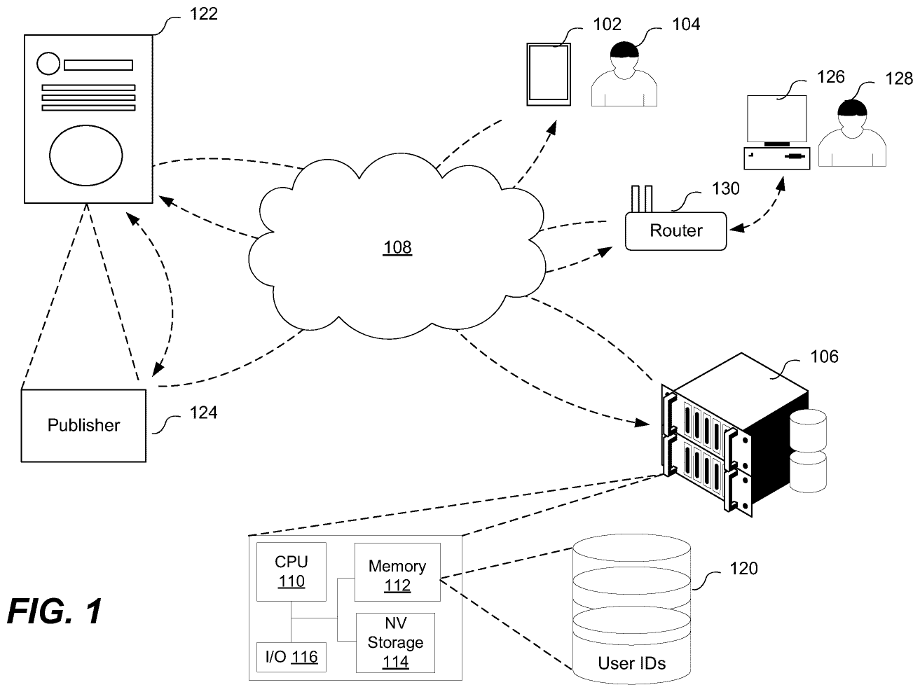

Embodiments are described below, by way of example only, with reference to FIGS. 1-7.

FIG. 1 depicts an embodiment of a system for identifying users with a publisher specific network based ID according to the present disclosure.

As depicted in FIG. 1, an user 104 may wish to consume content 122 using a device 102. The device 102 may be a tablet, a phone, a laptop, or other similar devices that can be configured to access and display the content 122. The device 102 may access content over a communication network 108. According to one embodiment, the communication network 108 is the internet. The device 102 may connect to the communication network 108 via different methods, which may include WiFi connection, wired/wireline connection, and mobile/cellular connection. The device 102 may access the network 108 by virtue of being a subscriber of a network provider. The content 122 may be one or more of media content, games, virtual merchandise shop, or other content typically available on the communication network 108 known to a person skilled in the art. The content 122 may be provided by a publisher 124, which can be an individual, company, corporation, organization, or any other entity with an interest in providing the content 122. The presentation of content 122 is not meant to be restrictive and may be presented in various frameworks provided that the framework complies with standard communications protocols and can be adapted to perform the methods described further herein. Typically, the content 122 may be provided in the form of a webpage or a mobile/desktop application. These frameworks may be configured for various communication methods, such as sending and receiving API calls.

The publisher 124 may wish to identify the user 104 or monitor the activities of the user 104 via the device 102. To that end, the publisher 124 may request to receive a unique identifier associated with the device 102. The publisher can request the unique identifier from a digital identity system 106 over the communication network 108. The digital identity system 106 may be a server or multiple servers networked together to function cooperatively. The server(s) may be physical server(s) or cloud based server(s). The digital identity system 106 may comprise a CPU 110, a non-transitory computer-readable memory 112, a non-volatile storage 114, and an input/output interface 116. The non-transitory computer-readable memory 112 comprises computer-executable instructions stored thereon at runtime which, when executed by the CPU 110, configure the digital identity system 106 to provide the publisher 124 with the unique identifier (e.g., publisher specific network based ID), as described in more detail herein. The non-volatile storage 114 has stored on it computer-executable instructions that are loaded into the non-transitory computer-readable memory 112 at runtime. The input/output interface 116 allows the server to communicate with one or more external devices such as the device 102 (e.g. via network 108), and the publisher 124. The non-transitory computer-readable memory 112 also comprises a user ID database 120 storing a number of unique identifiers for identifying user devices. Although not explicitly shown, the publisher may also be implemented as one or more servers in a manner analogous to the digital identity system 106 (e.g., comprising a CPU, a GPU, memories, etc.) to provide the content 122 and to communicate with devices 102, 126, and the digital identity system 106.

The digital identity system 106 may provide the publisher 124 with instructions for retrieving the unique identifier associated with the device 102. For example, the instructions may be a retrieval URL (e.g., for performing an API call) that is specific to the publisher 124. The publisher 124 may forward the instructions to the device 102, by for example, embedding the instructions in the content 122. As the user 104 consumes the content 122 using the device 102, the device 102 may execute the instructions, which opens communication between the device 102 with the digital identity system 106. The device 102 may also present additional information such as device information, source IP, subscriber information (identifying the device as a specific device subscribed to a network provider), and information identifying the publisher 124. The digital identity system 106 can parse the user ID database 120 for a unique identifier that corresponds to the information provided by the device 102. If a corresponding unique identifier is not found, a corresponding unique identifier is generated and stored in the user ID database 120. The unique identifier is then assigned to the device 102. As the device 102 consumes content 122, the publisher can access the unique identifier, which will identify and monitor the activity of the device 102 and by extension the user 104.

In accordance with the present disclosure, the unique identifier is specific to the publisher 124 and a different unique identifier may be assigned for a different publisher. As such, unique identifiers for one publisher is not useful for another publisher, which may better protect user privacy. Further, the digital identity system 106 may be able identify subscribers of one or more network providers. By determining unique identifiers based on the subscriber information, the digital identity system 106 may be able to identify the same subscriber, regardless of the format the subscriber is consuming the content 122 with (for example, using an application or on a webpage). For example, subscriber information may include a subscriber ID, which a particular network provider may associate/identify each of its subscriber. Additional subscriber information such as phone number, IP, name of subscriber, etc. may be stored in association with the subscriber ID. The unique identifier for each device (subscriber) may be determined by performing a mapping of subscriber information to unique identifier, for example, the IP and/or subscriber ID of a device may be determined, which is then mapped to a unique identifier. Moreover, if the user 104 were to replace the device 102 or perform a factory reset on the device 102, the digital identity system 106 may still be able to identify that the same subscriber is consuming the content 122, and as such provide the publisher 124 with the same unique identifier as to indicate the same user 104 is consuming the content 122.

According to a further embodiment of the present disclosure, a user 128 that is consuming content 122 may use a connection point 130 to connect a device 126 to the network 108. The device may be substantially the same as device 102. For example, the device 126 may connect to the network 108 using a wired or WiFi connection using the connection point 130, which may be, for example, a router/modem. The device 126 may be assigned a unique identifier in the same manner as the device 102. In this embodiment, the device 126 may present the digital identity system 106 with additional information related to the connection point 130. The digital identity system 106 can then assign a second unique identifier to the device 126, which may be determined and assigned based on information related to the connection point 130. That is, the second unique identifier may be understood as a “household identifier” (e.g., household ID) while the first unique identifier may be understood as a “device identifier” (e.g., user ID). More specifically, any device consuming the content 122 though a connection to the network 108 via the connection point 130 will share the same second unique identifier. This second unique identifier may help identify and monitor a group of users related with each other, for example, roommates or a family living together. The second unique identifier may also be stored in the user ID database 120. Note that while not explicitly shown, the devices 102, 126 can each be implemented in a manner analogous to the digital identity system 106 (e.g., comprising a CPU, a GPU, memories, etc.).

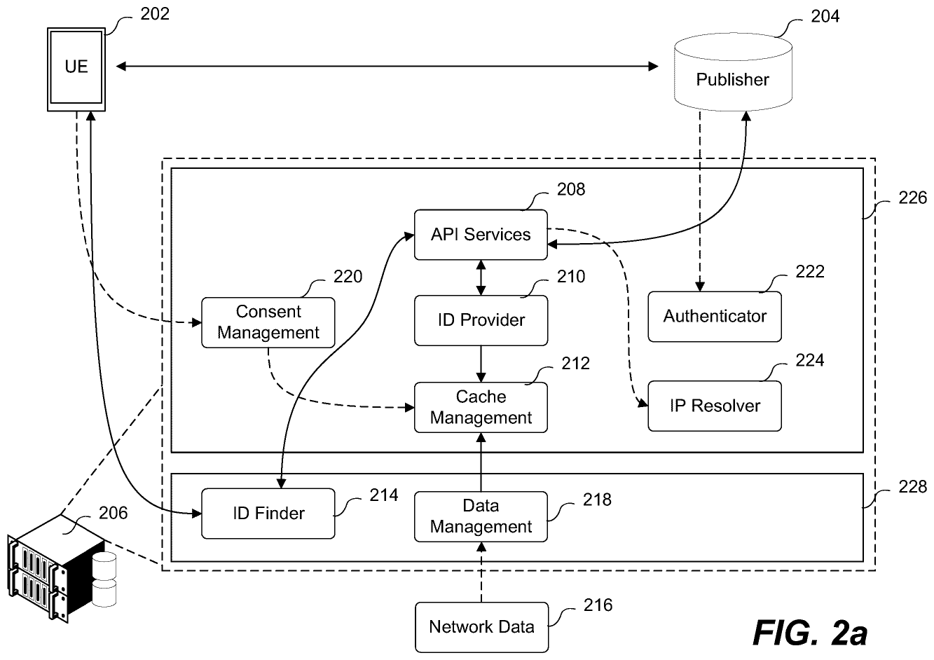

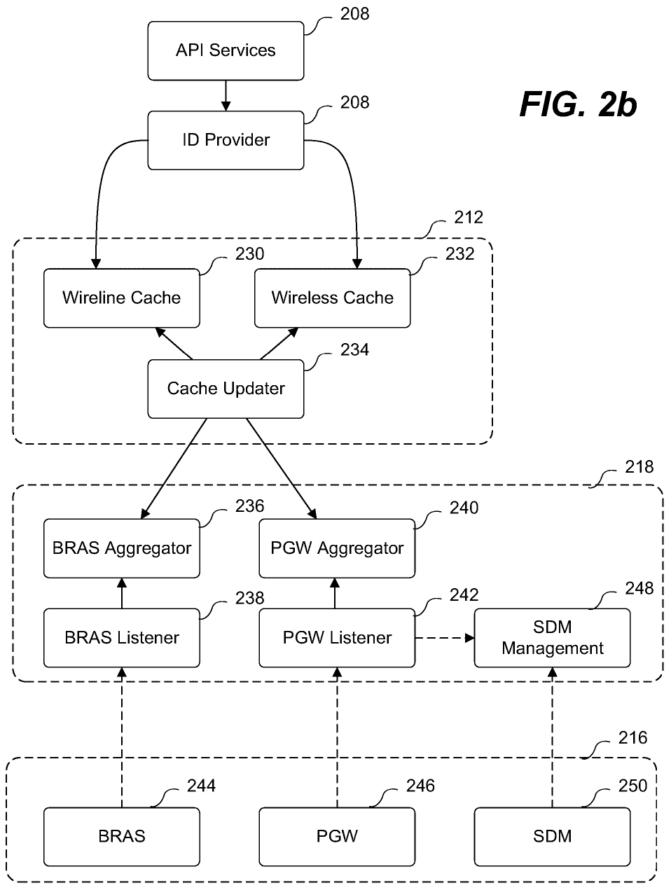

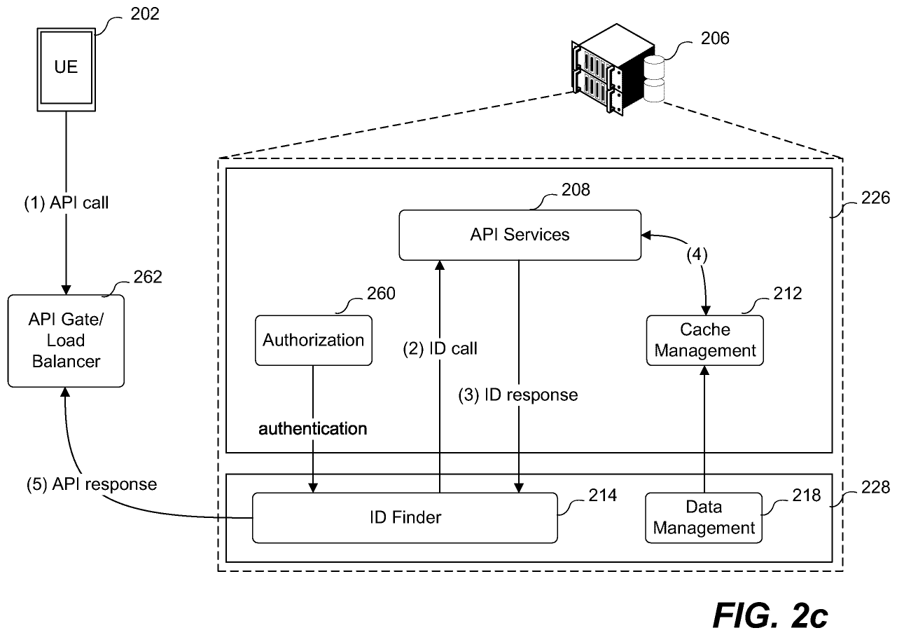

FIGS. 2a and 2b show an embodiment of a system for identifying users with a publisher specific network based ID showing the components. In particular, FIG. 2b shows the flow of different data in the system for identifying users with a publisher specific network based ID. Note that while the term “HTTP” is used herein with respect to FIGS. 2a-5 regarding requests and responses, each request/response may be alternatively an “HTTPS” request/response. In particular, requests/responses within the digital identity system may be “HTTP” requests/responses. In some implementations, requests/responses within the private server system may be HTTP” requests/responses.

As shown in FIG. 2a, a user equipment 202 may communicate with a publisher 204 to request content from the publisher 204 by, for example, accessing a publisher website or using an application by the publisher 204. The user equipment may be any typical electronic device capable of general wired or wireless communication known to a person skilled in the arts (e.g., a mobile device, a laptop, etc.). The publisher 204 may wish to receive a publisher specific network based ID (e.g., user ID) to identify and monitor the activities of the user equipment 202 by requesting a user ID (e.g., a network ID) from a digital identity system 206. The digital identity system 206 may be a server system with a hybrid framework. In particular, digital identity system 206 may comprise a public server system 226 and a private server system 228. The public server system 226 may be a cloud server system such as Google Cloud, where although the resources are private, the system is publicly accessible for allowed users and automatically scalable. The public server system 226 may comprise various components configured process requests and data that are less sensitive and more “public”. As depicted in FIG. 2a, the public server system 226 may comprise an API component 208, an ID provider component 210, a cache management component 212, a consent management component 220, an authenticator component 222, and an IP resolver component 224. API services implemented on the public server system 226 are internet facing and accessible for various API requested. The private server system 228 may be a local and/or physical server system separate from the public server system and not open for public access. That is, the private server system 228 may only process internal requests and specially authenticated requests. The private server system 228 may comprise various components configured to process requests and data that are more sensitive and “private”. For example, the private server system 228 may contain and process information relating to the subscriber to the network that the user equipment 202 is accessing the content with. As depicted in FIG. 2a, the private server system 228 may comprise an ID finder component 214 and a data management component 218. The publisher 204 may communicate with public server system 226 of the digital identity system 206, which may be achieved, for example, through the virtual connection point port 443. The user equipment 202 may communicate with the private server system 228 of the digital identity system 206. The communication between the public and private server systems can also be achieved through the virtual connection point of port 443. Such an arrangement can help enhance security by separately storing and handling of more/less sensitive information and requests while the maximizing the use of the highly compatible, easily implementable, and more cost effective public servers.

Upon receiving the request for content, the publisher 204 may request an URL (e.g., a GetURL) for retrieving a user ID from the API component 208 of the digital identity system 206. In particular, the publisher 204 and the digital identity system 206 (e.g., API component 208) may be configured to transmit and process API requests. As such, the publisher 204 may make an API call to the API component 208 for the retrieval URL of the user ID. The API component 208 may process the request and return the retrieval URL to the publisher 204. For example, the API component may route the incoming traffic to the appropriate service/component depending on the received request. Having received the retrieval URL, the publisher 204 then provides the retrieval URL to the user equipment 202. For example, the publisher may embed the retrieval URL in the content provided to the user equipment 202 without explicitly prompting or directing the user equipment 202 to follow the retrieval URL. It should be noted that the publisher 204 may provide the retrieval URL at any time. Specifically, the publisher 204 may first provide the requested content to the user equipment 202 and subsequently provide the retrieval URL once it is received from the API component 208 (for example, by embedding the retrieval URL in the content that is being displayed) such that there is no significant delay for the user equipment 202 in receiving the requested content. Alternatively, the retrieval URL may be provided at the same time as the requested content such that the user equipment 202 is identified as quickly as possible and/or to help ensure that the user equipment 202 that requests content is identified. Moreover, the retrieval URL may be unique to publisher 204. For example, the retrieval URL may include identifiers that identifies/specifies the particular publisher requesting the user ID. As such, a retrieval URL for a different publisher, even if obtained by the particular publisher 204, would not be useful.

Once the user equipment 202 reads or processes the retrieval URL provided by the publisher 204, the user equipment 202 is directed or implicitly prompted to communicate with the ID finder component 214 to retrieve the user ID. The ID finder component 214 may be configured to process user ID retrieval requests from the user equipment 202 and to retrieve the user ID, from for example, the public server system 226. To communicate with the ID finder component 214, the user equipment 202 may be quickly redirected to the private server system 228 (e.g., ID finder component 214) using the retrieval URL, for example, by means of an asynchronous HTTP call. The communication to the ID finder component 214 can be conducted not on a surface/interface level such that the content provided to the user equipment is not interrupted. The request may also contain additional information such as the source IP of the user equipment 202 and identifiers to identify the publisher 204. The ID finder component 214 may also extract a source IP from the request received from the user equipment. The ID finder component may then forward the request to (or “call”) the API component 208, for example, with an API call. The API component 208 may process the request for user ID by forwarding the request to the ID provider component 210. The ID provider component 210 may be configured to resolve the user ID request by returning the requested user ID to the API component 208. The ID provider component 210 can parse the cache management component 212 for a user ID that matches the user ID request. For example, the cache management component 212 may be parsed to determine if a user ID corresponding to the source IP and the publisher identifier is stored therein. If a corresponding user ID is found, the ID provider component 210 returns the user ID to the API component 208. If a parsing of the cache management component 212 determined that no user ID matches the user ID request (e.g., there does not exist a user ID for the provided source IP and publisher identifier), the ID provider component 210 may generate a unique corresponding the user ID request (for example, based on the source IP and publisher identifier). The generated user ID is returned to the API component 208 and stored in the cache management component 212. The API component 208 then returns the user ID of the user equipment 202 to the ID finder component 214.

The ID finder component 214 can assign the user ID to the user equipment 202, for example, using typical methods known to a person skilled in the art for digital identification over the communication network. The user ID may also be returned to the user equipment 202 by the asynchronous HTTP call made by the user equipment 202 to the ID finder component 214. The publisher 204 can then identity and monitor the activities of the user equipment 202 using the assigned user ID, which may be obtained or extracted by the publisher 204. The user ID may also be provided to the publisher 204 by means of the user equipment 202 making an asynchronous HTTP call to the publisher 204 in response to a call back to return the user ID by the publisher 204. According to another embodiment, the call to return the user ID may be embedded in the content provided to the user equipment 202 with or in the retrieval URL.

According to a further embodiment, a household ID may be provided to the publisher 204 alternatively or additionally to the user ID. The user equipment 202 may be accessing the content over a communication network using a connection point. For example, the user equipment 202 may be connected to the internet through a mobile network or a WiFi connection provided by a router (e.g., “wired” or “wireline” connection). Where the connection is wireline, information related to the connection point (e.g., a public IP) can also be included in the user ID request sent by the user equipment 202 to the ID finder component 214, which may be extracted by the ID finder component 214. Accordingly, the information related to the connection point can be received by the API component 208 and provided to the ID provider component 210. The ID provider component 210 can parse the cache management component to find a unique household ID corresponding to the information related to the connection point or generate such a household ID if one is not found. Subsequently, the household ID may be returned to the user equipment 202 and by extension the publisher 204 in the same manner as or with the user ID. That is, the ID finder 214 or the API services 208 can determine a connection type of the user equipment 202 to determine if the household ID should be generated, for example in addition to the user ID.

As depicted in FIG. 2a, the cache management component 212 may be a part of the public server system 226. The cache management component 212 may comprise one or more databases storing a plurality of user IDs and/or household IDs. Each user ID may be associated with a particular publisher and user device. The user ID may also be identified and associated with other information such as public/private IP. Each household ID may be associated with a particular publisher and a plurality of user devices (e.g., user IDs). The household ID may also be identified and associated using public IP. It is possible that the cache management component 212 contains empty entries, that is, it may store information such as public IP, private IP, and publisher information without an assigned/corresponding user ID or household ID. According to a further embodiment, the cache management component 212 may also store subscriber information in a case where user equipment are subscribed to a network provider to access content on the communication network. As depicted in FIG. 2a, the information stored in the cache management component 212 may be sourced from and updated by the data management component 218 of the private server system 228. The management component 218 may be configured to receive and process network data 216 that is provided to the digital identity system 206.

As depicted in FIG. 2b, the management and flow of data may be separated based on the source of the data. Generally, the pipeline for data management may be divided into a wireline stream and a wireless stream. The network data 216 may include different types of data. For example, as depicted in FIG. 2b, the network data 216 may comprise broadband remote access server (BRAS) information 244 and packet data network gateway (PGW) information 246. The BRAS information 244 may be the set of information related to the wireline access of the communication network (e.g., using a cable connection/connection using a modem/router) and can include data such as the access sessions and user data over the wireline connection (e.g., packets and radius messages). The PGW information 246 may be the set of information related to the wireless access of the communication network (e.g., using a mobile network connection) and can include data such as the access sessions and user data over the wireless connection (e.g., packets and radius messages). Correspondingly, the data management component 218 may comprise a BRAS listener 238 configured to process BRAS information 244 and a PGW listener 242 configured to process PGW information 246. The processed information from the BRAS listener 238 may be fed to a BRAS aggregator 236. Similarly, the processed information from the PGW listener 242 may be fed to a PGW aggregator 240. The aggregators may be configured to further process the received information by filtering and storing relevant data, which may be sent as a batch of data to the (cache updater 234 of) cache management 212. In some embodiments, subscriber data management (SDM) information 250 is also provided to the data management component 218 as network data 216. The SDM information 250 may include information related to the subscriber using the mobile network connection such as the phone number of the subscriber device. For example, the SDM information can include a plurality of subscriber IDs, which are associated with corresponding devices. These subscriber IDs persist through mobile number and device changes, which would be useful for identifying a particular subscriber. The SDM information 250 may be provided to a SDM management component 248 of the data management component 218 to be processed. For example, the SDM information 250 may be initially processed by a SDM notification handler to resolve notifications related to the subscriber information to and from the user device (e.g., updates to the phone number), which maybe stored in a cache storage. The PGW listener 242 may also extract the processed SDM information from the SDM management component 248 (e.g., the cache storage).

The cache management component 212 may comprise a cache updater 234, a wireline cache 230 and a wireless cache 232. The wireline cache 230 and the wireless cache 232 may be implemented as in-memory caches to reduce latency when the ID provider component 208 is parsing the caches for the user/household ID. The wireline cache 230 and wireless cache 232 may be databases respectively storing information from the wireline stream (e.g., data related to BRAS information) and information from the wireless stream (e.g., data related to the PGW information). Data from the BRAS aggregator 236 and the PGW aggregator 240 may be provided to or accessed by the cache updater 234 to populate, update or generate appropriate entries in the wireline cache 230 and the wireless cache 232 (e.g., the databases of the caches). According to some embodiments of the present disclosure, wireless information stored by the wireless cache 232 may include data related to the user ID, as described previously. The cache updater 234 may perform a mapping of private IP (used to access the communication network), which may be included in the PGW information 246, to user ID as to determine a particular user ID for a specific device. The process may be repeated or is specific for each publisher that would like to utilize the user ID. Further, the process may be repeated or is specific for particular regions, countries, or areas. According to a further embodiment, the mapping of private IP to user ID may be performed by first mapping the private IP to the phone number of the specific device, which can be then mapped to the user ID. Similarly, wireline information stored by the wireline cache 232 may include data related to the household ID, as described previously. The cache updater 234 may perform a mapping of public IP (used by the connection point to access the communication network), which may be included in the BRAS information 244, to household ID as to determine a particular household ID for a specific device. The process may be repeated or is specific for each publisher that would like to utilize the user ID. Further, the process may be repeated or is specific for particular regions, countries, or areas. According to a further embodiment, the mapping of public IP to household ID may be performed by first mapping the public IP to a subscriber identifier of the specific connection point used to the access the communication network, which can be then mapped to the public ID. The mapped information including the private IP, public IP, phone number, subscriber identifier, user ID, and household ID may be updated and stored in the corresponding cache database or be updated and stored in both the wireline cache 230 and the wireless cache 232. The mappings performed by the cache updater 234 may be performed in real time as data is received from the data management component 218. In some embodiments, the ID provider 208 may parse the wireline cache 230 for the household ID and the wireless cache 232 for the user ID. The data related to the user ID and the household ID may be stored in the caches as key value pairs, for example, as a no-SQL database. The caches may be easily scaled using the cloud server system, which can be done automatically based on factors such as CPU load and traffic.

In some embodiments of the present disclosure, the public server system 226 may comprise an authenticator component 222, as shown in FIG. 2a. The authenticator component 222 may be configured to determine if the publisher 204 is authorized to identify the user equipment 202 with the user ID. In particular, the publisher 204 may request authorization from the authenticator component 222 by, for example providing the authenticator component 222 with an access code (e.g., API key) or authorization token associated with the publisher 204. The authenticator component 222 may comprise one or more databases for storing publisher authorization information and user/admin authorization information. For example, the authenticator component 222 may comprise a publisher authentication token storage and user admin provisioning tables, which may be small structure tables. If the publisher 204 is an entity that is authorized to utilize user ID, that is, if the access code or authorization token presented by the publisher is valid (e.g., can be found in a database storing valid access codes or authorization tokens in relation to specific publishers), the authenticator component 222 may return a publisher access code or publisher authorization token to the publisher 204. For example, the authenticator component 222 can parse the one or more databases storing authorization information for a publisher access code or publisher authorization token that is unique to the publisher 204 based on the information provided by the publisher 204 during the authorization request (e.g., the access code or authorization token associated with the publisher 204). If the unique access code or token is not found, then it may be generated and stored. Similarly, admins or other authorized users can also request unique access codes or tokens from the authenticator component 222 (e.g., from a database storing user/admin authorization information), where the unique access codes or tokens may be generated if they are not found. The authorization request may be performed at any time. For example, the publisher may request authorization when they would like to track a particular user equipment (e.g., when the user equipment 202 is requesting content form the publisher 204) or before the publisher 204 requests the URL for retrieving a user ID from the API component 208. The publisher 204 may also request authorization at a fixed timing, for example, every hour or every day, or at an indeterminate time. To request the URL for retrieving a user ID, the publisher 204 may be required to present the unique access code or token to the API component 208. The retrieval URL may only be returned to the publisher 204 if the proper unique access code or token is presented. The unique access code or token may be valid for a set duration or indefinitely. That is, once the publisher 204 receives the unique access code or token, it may continue to use the same unique access code or token without requesting a new unique access code or token each time it request a retrieval URL until the unique access code or token expires or is no longer valid. Further, the publisher 204 may request and receive a publisher ID used to identify the publisher 204 alongside the unique access code or token.

In some embodiments of the present disclosure, the public server system 226 may comprise a IP or carrier resolver 224, as shown in FIG. 2a. The IP provider component 210 may be configured to only provide the user/household ID if the user equipment 202 is subscribed to a particular network provider. That is, if the user equipment 202 is subscribed to and/or accessing the communication network through a different network provider, IP provider component 210 may not be able to return the user/household ID (e.g., there is no corresponding entries in the cache management component 212 and not enough information can be extracted to generate the required ID(s)) when it is presented with the retrieval URL. As such, the IP resolver 224 may be configured to return the user ID or household ID when the user equipment 202 is a subscriber of the different network provider. In particular, the IP resolver 224 may comprise a IP repository or database storing IPs of all subscribers of the particular network provider. The API component 208 may forward the retrieval URL and associated information (e.g., source IP) from the user equipment to the IP resolver component 224. The IP resolver component 224 may look up the data associated with the retrieval URL (e.g., the source IP) in the IP database. If a corresponding IP is not found within the database, that is, if the user equipment 202 is subscribed to a different network provider, the IP resolver component 224 may forward the retrieval request to an external service responsible for providing the user/household ID by the different network provider. For example, IP resolver component 224 may provide the external services with retrieval URL and associated information (e.g., source IP). The external service may either return the request user/household ID or a retrieval URL corresponding to the different network provider to the IP resolve component 224, which may be returned to the user equipment 202 by the API component 208. In some embodiments, the API component 208 may forward the retrieval URL and associated information to the IP resolver component 224 to confirm that the user equipment 202 is subscribed to the particular network provider before forwarding said data to the ID provider component 212.

In some embodiments of the present disclosure, the public server system 226 may comprise a consent management component 220 configured to manage and update the consent status and settings of user equipment 202 with regard to the publisher 204. The publisher 204 may present the user equipment 202 with options to permit the publisher 204 to identify the user with the user/household ID, for example, using an opt-in/out prompt or page when the user equipment 202 initially accesses the content by the publisher 204. Alternatively, the user equipment 202 may be presented with the consent options when the device is initially registered or connected to the communication network. In such a case, the consent settings of the user equipment 202 may be applied globally to all publishers, rather then just the publisher 204. The consent management component 220 may comprise a consent updater configured to provide the cache management component 212 with the consent settings of the user equipment 202 to be stored in association with the other data pertaining to the user equipment 202. The user equipment 202 may also modify the consent settings at any time, which would cause the consent updater to update the consent settings stored in the cache management component 212. It should be noted that if consent for the publisher 204 to identify the user equipment 202 is not granted, the ID provider component 210 would not return the user/household ID to the user equipment 202. For example, when parsing the cache management component 212, it may be determined that the user equipment 202 (e.g., the IP associated with the user equipment 202) has granted publisher 204 the permission to track the user equipment 202. In such a case, the corresponding user/household ID may be generated or retrieved to be returned to the user equipment 202. Conversely, it may be determined that the user equipment 202 has denied such permissions, the user/household ID would not be generated or retrieved. The publisher 204 may prompt the user equipment 202 to update to provide consent settings if the user equipment 202 has denied consent for tracking or have not provided any settings at all.

It should be noted that the digital identity system 206 may be implemented as a multi-layer cloud solution stack. As described above, the infrastructure of the digital identity system 206 may use a hybrid server system. According to a particular embodiment, the infrastructure may be a set of virtual machines, for example, running Linux operating system in a public or private cloud. The public server system may be, for example, Google Cloud™, and the private server system may be implemented, for example, using OpenStack™. A particular layer may be the orchestration platform, which may be responsible for manage the cluster by providing facilities such as microservice deployment (e.g., the above described components), service exposure, load balancing traffic, routing, scaling, failover, etc. On the private server system and the public server system, this layer may be implemented, for example, respectively using Kubernetes™ (private server system) and Google Kubernetes™ Engine (public server system). A service mesh layer may be implemented to help support the management of microservices by providing service discovery, intelligent traffic routing, rate limiting, resiliency, security, fault-tolerance, telemetry, etc. On the private server system and the public server system, this layer may be implemented, for example, respectively using Istio™ (private server system) and Anthos™ Engine (public server system). A monitoring/altering layer may be implemented to help monitor the resources on the nodes (CPU, memory and Disk) usage, the containers liveness and resource used by each container running an application, traffic, performance, latency, etc. This layer may be managed by Cloud Monitoring and use SendGrid™ for notification handling and may be implemented using Elasticsearch™, Fluentd™, and Kibana™ stack; Prometheus™; Grafana™; and/or Kiali™. A cluster management layer may be implemented, which may be a dashboard through which all task management such as deployment, scaling, and maintenance are performed. This layer may be implemented with Kubernetes™ Dashboard. A tracing logging layer may be implemented to help provide distributed traces and logs for troubleshooting and for behavioral prediction. This layer may be managed with Cloud Stackdriver™ and may be implemented with OpenCensus™. Further, a microservices layer including the described components of the digital identity system 206 can also be implemented. The layer may be implemented using Java™, Spring Boot™, Redis™, JavaScript™, and/or React™. Further, for automation and DevOps operations, Gitlab™, Gitlab Runner™, and/or Helm Charts™ may be used. Additionally, SoapUI™ and/or Serenity RestAssured™ may be used as testing tools.

In some embodiments of the present disclosure, either or both of the public server system 226 and the private server system 228 may be implemented as distinct and individual server systems based on geographical areas. For example, there may be a public server system for servicing an east region and another public server system for servicing a west region. Similarly, there may be a private server system for servicing an east region and another private server system for servicing a west region. The individual region based servers of the same type may be substantially the same as one another, and each comprises the required individual component to function, and can operate independently. External traffic may be separated based on region to be directed to an appropriate regional system.

Although not depicted, the public server system 226 may comprise a publisher request logger configured to log publisher API requests to the digital identity system 206 for analytics. The private server system 228 may comprise an alert manager configured to handle any alerts transmitted by user equipment. Both the public and the private server systems may also comprise an error handler configured to manage the exceptions and errors report from the components of the digital identity system 206.

In accordance with another embodiment of the present disclosure, examples of particular API responses are shown below in Table 1. The below API requests and responses may be used by the ID finder 214 or the device (e.g., via the publisher 204) to retrieve the user/household ID, for example from the API services 208 (and the ID provider 210).

TABLE 1
Example API requests and responses

| Endpoint | /sip/api/userSmartId?publisher_id={publisherId}&public_ip={publicIP}&ca | |
|---|---|---|
| | rrier={carrier}&opt_in={optIn} | |
| Production | https://bop.smart-id.ca | |
| Domain | | |
| Request | HTTP | GET |
| | Method | |
| Request | Payload | Request Parameters: |
| | | publisher_id = Publisher ID |
| | | public_ip = Public IP of the source |
| | | carrier = Network carrier (B = Bell, NA = Apple Egress) |
| | | opt_in = Opt-in consent flag (true \| false \| unknown) |
| | | Request Header: |
| | | X-Forwarded-For = source IP of the user |
| | | X-API-KEY = client's API Key |
| | | X-API-SECRET = client's API secret (SHA256 hash) |
| | | Example: |
| | | /sip/api/userSmartId?publisher_id=pub_1&public_ip=100 |
| | | .0.10.240&carrier=B&opt_in=true |
| | | Request Header: |
| | | X-Forwarded-For=10.55.7.3 (Populated by service |
| | | provider) |
| | | X-API-KEY= e6817ae5-c5c9-47v4-ae68-3a2e72e1f27f |
| | | X-API-SECRET= |
| | | 368fae5801a0e46676fa98ab2331f979d7ccd92d92086ec |
| | | 7840d66235 |
| | | NOTE |
| | | opt_in=unknown, when publisher wants to check |
| | | consent status of UE in cache to decide if consent pop- |
| | | up needs be shown to the user or not |
| Response | Success | HTTP Status: 200 OK |
| | | Response Body |
| | | { |
| | | “smart_id”: <string>, |
| | | “showConsentPopup”: true \| false |
| | | } |
| | | EXAMPLE: |
| | | when opt_in=unknown and current opt-in consent |
| | | status in cache is not found / opt-out time outside |
| | | grace period, |
| | | { |
| | | “smart_id”: null, |
| | | “showConsentPopup”: true |
| | | } |
| | | when opt_in=unknown and current opt-in consent |
| | | status in cache = false + opt-out time inside grace |
| | | period, |
| | | { |
| | | “smart_id”: null, |
| | | “showConsentPopup”: false |
| | | } |
| | | when opt_in=true and current opt-in consent status |
| | | in cache = true, |
| | | { |
| | | “smart_id”: “MB-123e4567-m89b-12d3-b456- |
| | | 426614174000”, |
| | | “showConsentPopup”: false |
| | | } |
| | Failure | Validation Errors |
| | | HTTP Status: 400 Bad Request |
| | | { |
| | | “errorCode”: “400”, |
| | | “errorMessage”: <message with details on input> |
| | | } |
| | | Authorization Error |
| | | HTTP Status: 401 Unauthorized |
| | | { |
| | | “errorCode”: “401”, |
| | | “errorMessage”: “Unauthorized client” |
| | | } |
| | | User Not Found Error |
| | | HTTP Status: 404 Not Found |
| | | { |
| | | “errorCode”: “404”, |
| | | “errorMessage”: “User not found” |
| | | } |
| | | Opt_in consent denied |
| | | HTTP Status: 417 Error |
| | | { |
| | | “errorCode”: “417”, |
| | | “errorMessage”: “opt_in consent denied” |
| | | } |
| | | Service Errors |
| | | HTTP Status: 417 Internal Server Error |
| | | { |
| | | “errorCode”: “417”, |
| | | “errorMessage”: “Unexpected error. Please |
| | | Contact Administrator” |
| | | } |
| | | Service Unavailable |
| | | HTTP Status: 503 Service unavailable |
| | | { |
| | | “errorCode”: “503”, |
| | | “errorMessage”: “Service is unavailable” |
| | | } |

As shown in Table 1, the request can comprise the ID of the publisher, as described above, as well as the IP address of the publisher, the service provider of the user equipment 202 (e.g., for associating the user equipment 202 with a subscriber of the service provider), and a consent status of the user equipment 202 for using the user/household ID. The request also comprises the IP address of the user equipment 202 as well as the API key thereof for authenticating the user equipment. A response can comprise the user/household ID as well as a flag for prompting the user to consent or reject tracking using the user/household ID, a popup of which can be subsequently displayed on the user equipment 202. In cases where 10 a failure response is returned, the failure code and failure reason is provided, including unauthorized request (e.g., unauthorized publisher), user not found, no consent given, etc. Note that the use of network-based authentication (e.g., use of API calls, as described above and below) based on the user's IP address can allow the user equipment to be authenticated with or without the need for username/password input to improve the authentication process.

Referring now to FIG. 2c, another embodiment of a system for identifying users with a publisher specific network based ID is depicted. The system of FIG. 2c is substantially analogous to the system of FIGS. 2a and 2b, with differences described below.

As shown in FIG. 2c, the user equipment 202 can be directed to retrieve the network ID (user/household ID), for example by the publisher 204 using a redirection URL. As described above, the network ID can be retrieved using API requests/responses. In particular, the digital identity system 206 can be implemented on one or more servers 226, 228. An API endpoint can be provided by the system (e.g., on the servers) for interfacing with user equipment as well as to process API calls. As shown in FIG. 2c, the API endpoint can be implemented as a load balancer 262. The user equipment 202 can transmit the API request for the network ID to the ID finder 214 via the load balancer 262. The load balancer 262 can apply custom policies including SSL offload (removal of encryption) inspection and header injection (such as API header parameters), and redirection of incoming packets to the digital identity system (e.g., ID finder 214). In some embodiments, the load balancer 262 can be an API gateway. The ID finder 214 can then request for the network ID using another API call to the API services 208 of the public server system 226. A new API request may be generated from the API request of the user equipment 202. Alternatively, the same API request can be passed. Example API requests/responses are shown below in Tables 2-7.

The API services 208 can parse the cache management component 212 to retrieve the network ID of the user equipment 202 (or generate a new ID if none is available for the user equipment 202), as described above. Analogous to FIGS. 2a and 2b, the cache management 212 component stores network IDs of user equipment and is communicatively coupled to the data management component 218 to continuously update the cache management 212 and the network IDs. For example, subscriber information (for subscribers of the network provider) can be updated using the SDM management component 248 and PGW feeds (e.g., components 240, 242). The retrieved or generated network ID can be returned to the ID finder 214 via the response of the API request sent from the ID finder 214. The ID finder 214 can then return the network ID to the user equipment 202 as a response to the API request from the user equipment 202 through the load balancer 262. In some embodiments, the API services 208 can also directly return the network ID to the user equipment 202 without first returning the network ID to the ID finder 214 using a response to the received API request.

In some embodiments, upon receiving the request, the API services 208 can first process the request to determine a connection type of the user equipment 202. In particular, the API services 208 can determine if the connection is under IPV6 or IPv4 protocol. For IPV6 requests, the API services 208 can directly extract the source IP of the user equipment from the request and return the corresponding network ID, as described above. For IPV4 requests, the API services 208 can require the user equipment 202 to first return their source IP, for example by returning/embedding a redirection URL/API call to the user equipment 202 (e.g., via the ID finder 214). In particular, the redirection URL/API call can be an instruction for retrieving the network ID and/or the source IP. The user equipment 202 can trigger the redirection URL/API call and be directed to the ID finder 214. The ID finder 214 can then determine/extract the source IP from the redirection URL/API call and embed/inject the source IP into an API call for the network ID to the API services 208. The API services 208 can subsequently extract the source IP to determine the network ID, as described above.

In some embodiments, an authorization component 260 may be provided on the public server system 226. In particular, the authorization component 260 can process, verify, and authenticate requests to the public server system 226 such that only authorized requests, (e.g., authorized API requests from the ID finder 214) are accepted by the public server system 226 and processed by the API services 208.

In some embodiments, the user equipment 202 can request the ID finder 214 to request and return a profile of the user equipment 202 in addition to the network ID (e.g., “subid”). For example, the publisher 204 can direct the user equipment 202 to retrieve the user profile by using a different API request. The user profile can additional comprise data including the phone number of the user equipment (e.g., mobile phone number of wireline phone number, “mdn”), a sub-type of the subscriber account of the user equipment 202 for the service provider (“e.g., “acountSubType”), and a preferred language of the user equipment 202 (e.g., “eamLanguage”). The phone number, account sub-type, and the preferred language can be retrieved or generated by the data management 218 then stored in the cache management component 212 in a manner analogous to those described in FIGS. 2a and 2b.

Table 2 below shows an overview of the example API requests and responses. Further examples are shown in Tables 3-7. In particular, Table 3 is directed to API requests/responses to and from the user equipment 202 for network ID retrieval. Tables 4 and 5 are directed to API requests/responses to and from the ID finder 214 for network ID and profile retrieval. Tables 6 and 7 are directed to internal API requests/responses to and from the API services 208 (e.g., for parsing the cache management component 212) for network ID and profile retrieval. In Tables 2-7, “x-forwarded-for” corresponds to the source IP of the user equipment 202, which can be determined by the API services 208 (using iRule for IPV6 requests) and/or the ID finder 308. Note that underlined portions are optional.

TABLE 2
Overview of API requests and responses

| API | Requests | Response (happy path) |
|---|---|---|
| Service-api | Header: | JSON |
| | x-forwarded-for (derived from | { |
| | network) | ″subid″: |
| | x-api-key (for auth) | ″123456_wap2.bellmobility.ca″ |
| | x-api-secret (for auth) | } |
| | Request parameter: | |
| | Application_ID | |
| | responseType = service-api | |
| Profile | Header: | JSON |
| | x-forwarded-for (derived from | { |
| | network) | ″mdn″: ″12345678901″, |
| | x-api-key (for auth) | ″subid″: |
| | x-api-secret (for auth) | ″123456_wap2.bellmobility.ca″ |
| | Request parameter: | “eamLanguage”: “EN” |
| | Application_ID | “acountSubType”:”A” |
| | responseType = profile | } |
| Redirect | Header: | HTTP/302 Redirect to |
| | | www.test.ca&eamLanguage=X& |
| | x-forwarded-for (derived from | subId=123456_wap2.bellmobility.ca |
| | network) | &accountSubType=A |
| | x-api-key (for auth) | |
| | x-api-secret (for auth) | |
| | Request parameter: | |
| | Application_ID | |
| | responseType = redirect | |
| | callback_host= www.test.ca | |

As shown in Table 2, embodiments of the present disclosure can also redirect the user equipment 202 to a personalized webpage corresponding to their subscriber account to the network provider. The user equipment 202 can provide information such as their preferred language. In some embodiments, the user can provide consent authorization via the webpage as well as view and update their subscriber information.

TABLE 3
Example API requests and responses of user equipment

| Endpoint | /sip/api/userSubscriberId?responseType={mini-profile or service- | |
|---|---|---|
| | api}?application_id={applicationId}&public_ip={publicIP} | |
| Production | https://nsi.smart-id.ca | |
| Domain | | |
| Request | HTTP | GET |
| | Method | |
| Request | Payload | Request Parameters: |
| | | responseType = Mini-profile (returns mdn and subid2) or |
| | | service-api (returns only subid2) |
| | | application_id= |
| | | application / Serv ID |
| | | public_ip = Public IP |
| | | of the source |
| | | Request Header: |
| | | X-Forwarded-For = |
| | | source IP of the user |
| | | X-API-KEY = client's |
| | | API Key |
| | | X-API-SECRET = client's API secret (SHA256 hash) |
| | | Example: |
| | | /sip/api/userSubscriberId?application_id=pub_1&public_ip=100.0. |
| | | 10.240 |
| | | Request Header: |
| | | X-Forwarded-For=10.55.7.3 (Populated by F5) |
| | | X-API-KEY= e6817ae5-f5c9-47d4-ae48-3a2e72e1f27f |
| | | X-API-SECRET= |
| | | 368fae5801a0e46676fa98abf53e8e24831f979d7ccd92d92086ec |
| | | 7840d66235 |
| Response | Success | HTTP Status: 200 OK |
| | | Response Body |
| | | { |
| | | “subid”: <string> |
| | | } |
| | | { |
| | | “mdn”: <string>, |
| | | “subid”: <string> |
| | | } |
| | Failure | Validation Errors |
| | | HTTP Status: 400 Bad Request |
| | | { |
| | | “errorCode”: “400”, |
| | | “errorMessage”: <message with details on input> |
| | | } |
| | | Authorization Error |
| | | HTTP Status: 401 Unauthorized |
| | | { |
| | | “errorCode”: “401”, |
| | | “errorMessage”: “Unauthorized client” |
| | | } |
| | | User Not Found Error |
| | | HTTP Status: 404 Not Found |
| | | { |
| | | “errorCode”: “404”, |
| | | “errorMessage”: “User not found” |
| | | } |
| | | Service Errors |
| | | HTTP Status: 417 Internal Server Error |
| | | { |
| | | “errorCode”: “417”, |
| | | “errorMessage”: “Unexpected error. Please Contact |
| | | administrator” |
| | | } |
| | | Service Unavailable |
| | | HTTP Status: 503 Service unavailable |
| | | { |
| | | “errorCode”: “503”, |
| | | “errorMessage”: “Service is unavailable” |
| | | } |

TABLE 4
Example network ID API requests and responses of ID finder

| Endpoint | /dip/api-service/service- | |
|---|---|---|
| | api?application_id={applicationId}&public_ip={publicIP}&private_ip={privatelP}&r | |
| | egion={region} | |
| Request | HTTP Method | GET |
| Request | Payload | Request Parameters: |
| | | application_id= |
| | | application / |
| | | Serv ID |
| | | public_ip = |
| | | Public IP of |
| | | the source |
| | | private_ip = Private IP of |
| | | the source (in case of |
| | | wireless) |
| | | region = Region of ID |
| | | Finder hosted instance |
| | | (East / West) |
| | | channel = Wireless/Wireline (Wireless) |
| Response | Success | HTTP Status: 200 OK |
| | | Content Type: application/json |
| | | Payload |
| | | { |
| | | “subId”: <string>, |
| | | } |
| | Failure | Validation Errors |
| | | HTTP Status: 400 |
| | | { |
| | | “errorCode”: <INTERNAL_ERROR_CODE>, |
| | | “errorMessage”: “Invalid request. Missing <parameter>” |
| | | } |
| | | User Not Found |
| | | HTTP Status: 404 |
| | | { |
| | | “errorCode”: <INTERNAL_ERROR_CODE>, |
| | | “errorMessage”: “User Not Found in Cache” |
| | | } |
| | | Other Service Errors |
| | | HTTP Status: 417 |
| | | { |
| | | “errorCode”: <INTERNAL_ERROR_CODE>, |
| | | “errorMessage”: “Unexpected error. Please contact |
| | | Administrator” |
| | | } |
| | | Other Service Errors |
| | | HTTP Status: 503 |
| | | { |
| | | “errorCode”: <INTERNAL_ERROR_CODE>, |
| | | “errorMessage”: “Service is unavailable” |
| | | } |

TABLE 5
Example user profile API requests and responses of ID finder

| Endpoint | /dip/api-service/mini- | |
|---|---|---|
| | profile?application_id={applicationId}&public_ip={publicIP}&private_ip={privateI | |
| | P}&region={region | |
| Request | HTTP | GET |
| | Method | |
| Request | Payload | Request Parameters: |
| | | applicatio |
| | | n_id= |
| | | applicatio |
| | | n / Serv |
| | | ID |
| | | public_ip |
| | | = Public |
| | | IP of the |
| | | source |
| | | private_ip = Private IP |
| | | of the source (in case of |
| | | wireless) |
| | | region = Region of ID |
| | | Finder hosted instance |
| | | (East / West) |
| | | channel = Wireless/Wireline |
| Response | Success | HTTP Status: 200 OK |
| | | Content Type: application/json |
| | | Payload |
| | | { |
| | | “subId”: <string>, |
| | | “mdn”: <string> |
| | | } |
| | | Note: subid can be mobile number or subid depending if |
| | | channel is wireless or wireline |
| | Failure | Validation Errors |
| | | HTTP Status: 400 |
| | | { |
| | | “errorCode”: <INTERNAL_ERROR_CODE>, |
| | | “errorMessage”: “Invalid request. Missing <parameter>” |
| | | } |
| | | User Not Found |
| | | HTTP Status: 404 |
| | | { |
| | | “errorCode”: <INTERNAL_ERROR_CODE>, |
| | | “errorMessage”: “User Not Found in Cache” |
| | | } |
| | | Other Service Errors |
| | | HTTP Status: 417 |
| | | { |
| | | “errorCode”: <INTERNAL_ERROR_CODE>, |
| | | “errorMessage”: “Unexpected error. Please contact |
| | | Administrator” |
| | | } |
| | | Other Service Errors |
| | | HTTP Status: 503 |
| | | { |
| | | “errorCode”: <INTERNAL_ERROR_CODE>, |
| | | “errorMessage”: “Service is unavailable” |
| | | } |

TABLE 6
Example network ID API requests and responses of API services

| Endpoint | /dip/id-lookup/user- | |
|---|---|---|
| | subid?application_id={applicationId}&public_ip={publicIP}&private_ip={privateIP | |
| | }&region={region} | |
| Request | HTTP | GET |
| | Method | |
| Request | Payload | Request Parameters: |
| | | application_id= application / Serv ID |
| | | public_ip = Public IP of the source |
| | | private_ip = Private IP of the source (in case of wireless) |
| | | region = Region of ID |
| | | Finder hosted instance |
| | | (East / West) |
| | | channel = Wireless/Wireline |
| | | (determined by the |
| | | network) |
| Response | Success | HTTP Status: 200 OK |
| | | Content Type: application/json |
| | | Payload |
| | | { |
| | | “subId”: <string> |
| | | } |
| | | Note: subid can be mobile number or subid depending if |
| | | channel is wireless or wireline |
| | Failure | Validation Errors |
| | | HTTP Status: 400 |
| | | { |
| | | “errorCode”: <INTERNAL_ERROR_CODE>, |
| | | “errorMessage”: “Invalid request. Missing <parameter>” |
| | | } |
| | | User Not Found Error |
| | | HTTP Status: 404 Not Found |
| | | { |
| | | “errorCode”: “404”, |
| | | “errorMessage”: “User not found” |
| | | } |
| | | Other Service Errors |
| | | HTTP Status: 500 |
| | | { |
| | | “errorCode”: <INTERNAL_ERROR_CODE>, |
| | | “errorMessage”: “Unexpected error. Please contact |
| | | Administrator” |
| | | } |
| | | Other Service Errors |
| | | HTTP Status: 503 |
| | | { |
| | | “errorCode”: <INTERNAL_ERROR_CODE>, |
| | | “errorMessage”: “Service is unavailable at the moment” |
| | | } |

TABLE 7
Example user profile API requests and responses of API services

| Endpoint | /dip/id-lookup/mini- | |
|---|---|---|
| | profile?application_id={applicationId}&public_ip={publicIP}&private_ip={privateI | |
| | P}&region={region} | |
| Request | HTTP | GET |
| | Method | |
| Request | Payload | Request Parameters: |
| | | application_id= application / Serv ID |
| | | public_ip = Public IP of the source |
| | | private_ip = Private IP of the source (in case of wireless) |
| | | region = Region of ID Finder hosted instance (East / West) |
| | | channel = Wireless/Wireline (determined by the network) |
| Response | Success | HTTP Status: 200 OK |
| | | Content Type: application/json |
| | | Payload |
| | | { |
| | | “subId”: <string>, |
| | | “mdn”: <string> |
| | | } |
| | | Note: subid can be mobile number or subid depending if |
| | | channel is wireless or wireline |
| | Failure | Validation Errors |
| | | HTTP Status: 400 |
| | | { |
| | | “errorCode”: <INTERNAL_ERROR_CODE>, |
| | | “errorMessage”: “Invalid request. Missing <parameter>” |
| | | } |
| | | User Not Found Error |
| | | HTTP Status: 404 Not Found |
| | | { |
| | | “errorCode”: “404”, |
| | | “errorMessage”: “User not found” |
| | | } |
| | | Other Service Errors |
| | | HTTP Status: 500 |
| | | { |
| | | “errorCode”: <INTERNAL_ERROR_CODE>, |
| | | “errorMessage”: “Unexpected error. Please contact |
| | | Administrator” |
| | | } |
| | | Other Service Errors |
| | | HTTP Status: 503 |
| | | { |
| | | “errorCode”: <INTERNAL_ERROR_CODE>, |
| | | “errorMessage”: “Service is unavailable at the moment” |
| | | } |

As shown above, various failure cases are also indicated, for example for improper request syntax (invalid request), no user found, services unavailable, etc.

In some embodiments, API services 208 can also log and store (e.g., in cache management component 212) API requests from the publisher. Example API requests/responses to and from the publisher 204 are shown below in Table 8. In particular, the request can comprise a number of parameters including: a network protocol of the user equipment 202 (e.g., IPv6 or IPv4), a connection channel (e.g., wireless or wireline), and subsidiary identifier of a subset/subgroup of the publisher. Note that underlined portions are optional.

TABLE 8
Example API requests and responses of publishers

| Endpoint | /dip/publisher-request-logger/log | |
|---|---|---|
| Request | HTTP | POST |
| | Method | |
| Request | Payload | Request Header: |
| | | X-Correlation-ID |
| | | Request Body: |
| | | publisher_id = Application ID |
| | | public_ip = public IP address |
| | | of UE (IPv4 or IPv6) |
| | | private_ip = private IP address |
| | | of UE (IPv4) |
| | | network_id = assigned user's |
| | | Network ID |
| | | channel = |
| | | Wireless/Wir |
| | | eline |
| | | carrier = B |
| | | (Bell) / O |
| | | (Others) |
| | | subsidiary_id = company id |
| | | associated with child publisher |
| | | response_code = HTTP status |
| | | code (success / error) |
| | | state = indicates if the transaction |
| | | state of the request |
| | | region = indicates the region of |
| | | the user request |
| | | opt_in = user's Opt-in consent flag |
| | | opt_out_timestamp = user's Opt-out timestamp (in UTC) |
| | | event_timestamp = transaction timestamp (in UTC) |
| Response | Success | HTTP Status: 200 OK |
| | | No Response Body |
| | Failure | Validation Errors |
| | | HTTP |
| | | Statu |
| | | s: 400 |
| | | { |
| | | “errorCode”: <INTERNAL_ERROR_CODE>, |
| | | “errorMessage”: “Invalid request. Missing <parameter>” |
| | | } |
| | | Other Service Errors |
| | | HTTP |
| | | Status: 500 |
| | | { |
| | | “errorCode”: <INTERNAL_ERROR_CODE>, |
| | | “errorMessage”: “Unexpected error. Please contact |
| | | Administrator” |
| | | } |

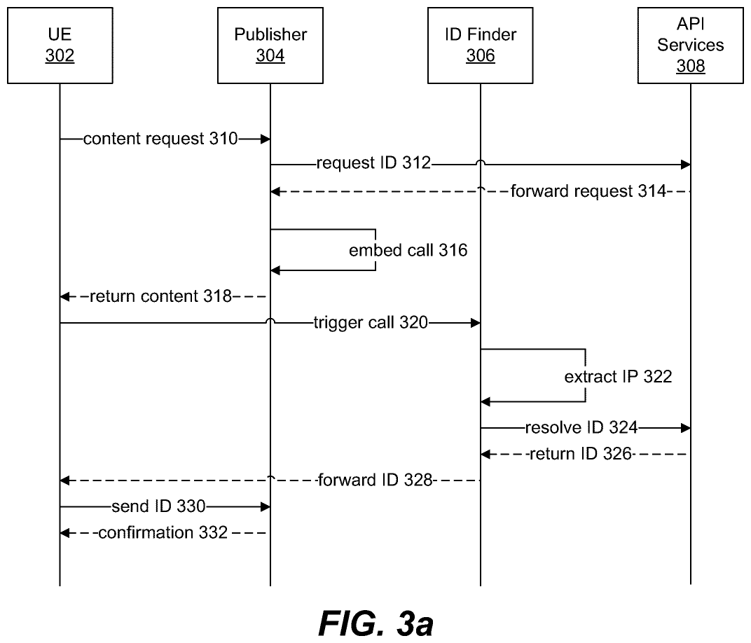

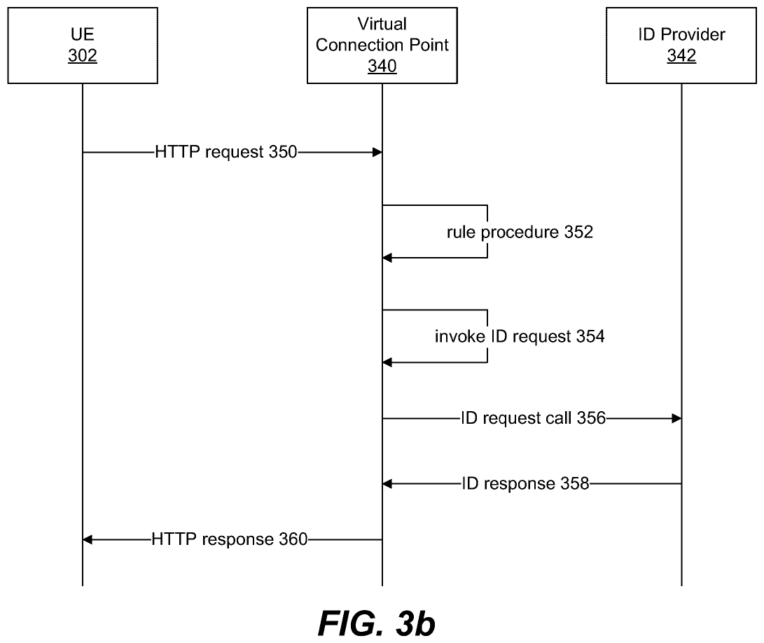

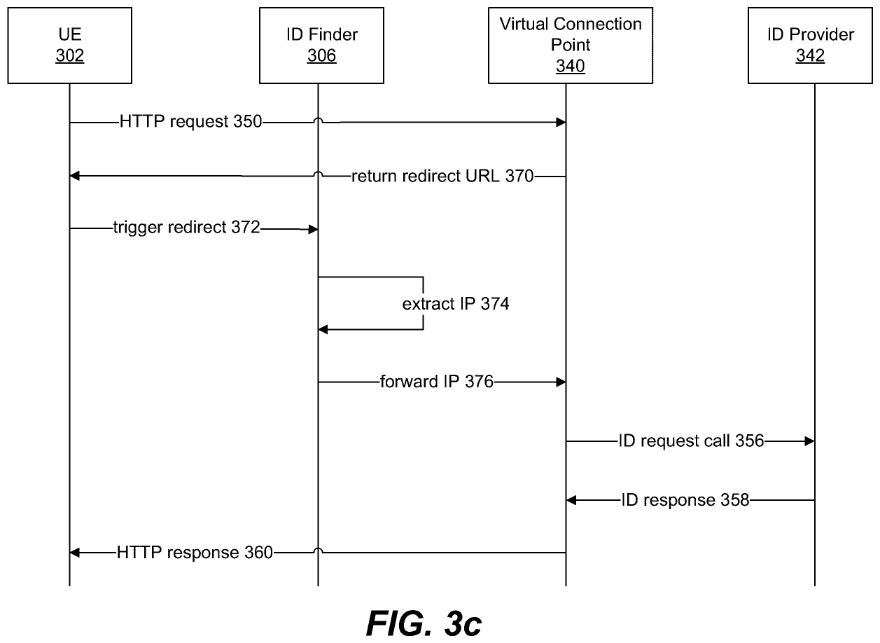

FIG. 3a shows a diagram of the process of obtaining a publisher specific network based ID (e.g., network ID). As depicted in FIG. 3a, an user equipment 302 may request content 310 from a publisher 304. For example, the user equipment 302 may be any electronic device configured to access content over a communication network (e.g., the internet). The user equipment 302 may, as an example, access content belonging to the publisher with an URL (e.g., get http:// . . . ) through an app or web browser. Once the request is received by the publisher 304, the publisher 304 may request a network ID of the user equipment 304 (312) from API services 308. The network ID may be a unique user ID and/or household ID that is specific to the publisher 304. This request may be performed by means of an asynchronous HTTP JavaScript call that is triggered on the user equipment 302 (e.g., the web browser that the content is requested on). Notably, the publisher can cause the user equipment 302 to make an API call to API services 308 to retrieve the network ID.

The API services 308 may be operated by a digital identity system and can be configured to process various requests related to network IDs. To request the network ID, the publisher 304 may be required to provide to the API services 308 a public IP of the user equipment 302 to request access to the content and a publisher identifier used to identify the publisher. In particular, the public IP may be extracted from the content request and the publisher identifier may be assigned to the publisher 304 (e.g., by the API services 308 of the digital identity system), for example, during a publisher authentication process, as described above. This process may also be performed to confirm the eligibility of identifying the user equipment 302 with the network ID. That is, by sending the public IP of the user equipment 302 to the API services 308, the API services 308 may determine if the public IP is associated with a supported network provider (e.g., a network provider that has provided subscriber information to the digital identity system). If the public IP is associated with a supported network provider, the process may proceed as described herein. If the public IP does not belong to a supported network provider, the process may be terminated as it would not be possible to return a network ID. The publisher 304 may also be required to provide a authorization token or access code that grants the publisher 304 authorization to request network IDs. The process for the publisher 304 to obtain authorization was described above with respect to FIG. 2a. It is assumed for the process described with regard to FIG. 3a that the publisher 304 is authorized to request network IDs. It should also be noted that the processed depicted in FIG. 3a is performed only when user equipment 302 have consented to identification via the network ID. That is, it is assumed here that user equipment 302 have previously given consent for the publisher 304 to identify the user equipment 302 using the network ID.

The API services 308 may authenticate the network ID request based on the information provided by the publisher 304. Once authenticated, the API services 308 may forward the request 314. That is, the API services 308 may provide a retrieval URL to the publisher 304, which may be an URL that is pointed to an ID finder 306 of the digital identity system configured to provide network IDs. The retrieval URL may be provided to the publisher via the response of an asynchronous HTTP JavaScript call from the user equipment 302 (e.g., the web browser that the content is requested on). It should be noted that the publisher 304 would not be able to directly use the retrieval URL itself to obtain the network ID. As such, the publisher 304 may provide the retrieval URL to the user equipment 302 by embedding the retrieval URL in the content that is requested. For example, the publisher 304 may embed an asynchronous HTTP JavaScript call to the retrieval URL in the HTML of the requested content (embed call 316). In some embodiments, the publisher 304 may only need to request (and receive) the retrieval URL once, as the retrieval URL may be only based the publisher and is not specific to a particular user device. In some embodiments, the retrieval URL may be additionally specific to a web browser that the content is being accessed from. That is, the same retrieval URL may be provided to different user devices.

The publisher 304 then renders or returns the requested content to the user equipment 302 with the retrieval URL embedded in the content 318. In particular, the publisher 304 can return the HTML response from 316 to the user equipment 302. For example, the publisher 304 can display the HTML web page with the embed asynchronous HTTP JavaScript call to the user equipment 302. It should be noted that at this stage, the publisher has yet to be provided with the network ID. Further, the user equipment 302 may also be yet to be assigned the network ID. However, by providing the content before the publisher 304 receives the network ID, the user equipment may access the content with minimal delay such that user experience is not affected.

By accessing the content, the user equipment 302 is directed by the retrieval URL to communicate with an ID finder 306 of the digital identity system to request the network ID (trigger call 320) where the ID finder 306 may be configured to provide network IDs in response to requests by the user equipment 302. In particular, as the content is rendered by the user equipment 302 (for example, a browser of the user equipment 302 renders a webpage from the publisher 304), the user equipment 302, for example, by means of the browser, can trigger an asynchronous HTTP call to or with the retrieval URL (e.g., the asynchronous HTTP JavaScript call) to the ID finder 306. Further, the ID finder 306 may be managed on a private server or network for increased security.

The ID finder 306 can process the request for the network ID by extracting a source IP of the user equipment 302 from the request 322. The extraction of the source IP may be based on a subscriber information of the user equipment 302 where the user equipment 302 utilizes services (e.g., is a subscriber) of a communication provider, as described above. The ID finder 306 can then communicate with (call) the API services 308 and requests the network ID to be assigned to the user equipment 302. In particular, the ID finder 306 can forward the source IP to the API services 308. Specifically, the ID finder 306 can request the network ID from the API services 308 using an API request by embedding/injecting the source IP into the header of API request. The API services 308 resolves this request 324. The API services 308 or an associated service may parse a database (e.g., a cache implemented on the same server as API services 308) for a corresponding network ID or generate a network ID if one is not found (and store the generated network ID), for example, based on the source IP. The API services 308 can return the network ID to the ID finder 306 (return ID 326). The ID finder 306 may then return the network ID to the user equipment 302 (forward ID 328) such that the user equipment 302 is assigned with the network ID. In some embodiments, the API services 308 can also directly return the network ID to the user equipment 302 without first returning the network ID to the ID finder 306.

It should be noted that the network ID may be stored in the local session of the browser that the content is being accessed from. That is, if the user equipment 302 terminates the current browser session, the network ID may be purged from the browser of the user equipment 302. If the user equipment 302 requests content from the publisher 304 again, the publisher 304 may have to request the network ID of the user equipment 302 again (and have the network ID be assigned to the user equipment 302). Further, if the user equipment 302 requests content form the publisher 304 via a different browser, the publisher 304 may also have to request the network ID again to be assigned to the user equipment 302. However, in all cases, the network ID assigned to the user equipment 302 would be the same.

The user equipment 302 may provide the returned network ID to the publisher 304 (send ID 330). In particular, the user equipment 302 may respond or process a request or call by the publisher 304 to return the network ID to the publisher 304. For example, the browser of the user equipment 302 may trigger a asynchronous HTTP JavaScript call to a callback URL of the publisher 304 to return the network ID. Upon receiving the network ID, a confirmation may be returned to the user equipment 302 (confirmation 332).

Referring now to FIG. 3b, another embodiment of a process for obtaining a publisher specific network based ID (e.g., network ID) is depicted. In FIG. 3b, the publisher 304 and ID finder 306 are not shown for brevity. Further, a virtual connection point 340 is shown instead of API services 308 in addition to showing an ID provider 342. The virtual connection point 340 can be a tenant virtual connection point implemented using a F5 Big IP™ gateway platform, which can comprise the API services 308. The virtual connection point 340 can be implemented on/with a server system (e.g., public server system) for traffic management and processing, including the processing of API requests/responses. In particular, the virtual connection point 340 can be used to implement one or more rules for incoming/outgoing traffic (e.g., to and from the servers system), which can be applied to API calls to the server system.

At 350, the user equipment 302 makes a request for a network ID to the virtual connection point 340, for example using an HTTP request or API request. The request can be made at the direction of a publisher that the user equipment 302 is requesting content from. The request can be made directly to the virtual connection point 340 or indirectly via the ID finder, as described above. The request to the virtual connection point 340 can invoke (e.g., and be processed using) one or more rule applications. The rules may be implemented using iRule procedures. At 352, the rules are applied to the request. The rules may be standard policy rules such as load management and traffic routing rules. One rule can invoke the ID provider 342 (354).

That is, a rule can cause the virtual connection point 340 to call the ID provider 342 to request the network ID from the ID provider 342. Specifically, iRule can be used as a network policy for performing SSL offload of incoming network packets. The incoming packets can be inspected, and based on the API request, header injections can be performed into the packet (e.g., source IP injection) such that ID provider 342 has the full information to respond appropriately. Note that as shown in FIG. 3b, some embodiments of the present disclosure does not require the request to first pass through the ID finder.

At 356, the virtual connection point 340 makes a request to the ID provider 342 based on the rule invocation to request the network ID, for example using an HTTP or API request. The request can comprise the source IP of the user equipment, which the ID provider 342 can use to match the user equipment to a particular subscriber of a network provider, as described above. The network ID corresponding to the subscriber can be parsed from a database or generated if not available by the ID provider 342, as described above. At 358, the network ID is returned to virtual connection point 340 from the ID provider 342 (e.g., as HTTP/API response) and subsequently returned/assigned to the user equipment 302 via the HTTP/API response at 360.

In particular, the embodiment of the present disclosure as depicted in FIG. 3b can be applicable for user equipment operating under the IPV6 protocol, such as for user equipment making the HTTP/API request using IPV6. In particular, IPv6 protocol can allow the IP address (e.g., source IP) of the user equipment 302 to form a portion of or be embedded in the (HTTP/API) request. Accordingly, the virtual connection point 340 can directly extract and/or provide the source IP of the user equipment 302 to the ID finder 306 for determining the corresponding subscriber and network ID.

Another embodiment of a process for obtaining a publisher specific network based ID (e.g., network ID) is depicted in depicted in FIG. 3c, which can be applicable for user equipment operating under both IPv4 and IPV6 protocols, but more particularly to those operating under IPv4 protocols. The process is substantially analogous to the process of FIG. 3b, with differences highlighted below.

After receiving the request at 350, the virtual connection point 240 (or the ID finder, for example if the request is sent indirectly) can first determine the connection protocol for the request (e.g., for the user equipment 302). In particular, the virtual connection point 340 can determine if the request is made under IPv4 or IPV6. As described above, the source IP may not be provided directly within the request itself under IPv4. Accordingly, if the request is made under IPv4, API services 308 (e.g., virtual connection point 340) can first redirect the user equipment 302 to retrieve their source IP, for example via a retrieval/redirect URL or API call returned to the user equipment or embedded in content at 370. In some embodiments, the virtual connection point 340 can make an API call (e.g., comprising source IP information or such that the source IP can be determined) to the user equipment 302 to direct the user equipment to make an API call to the ID finder 306 at 372. Correspondingly, the user equipment 302 is redirected to ID finder 306, which extracts the source IP based on the API call at 374 and forwards the source IP to the virtual connection point 340, for example by forwarding/transmitting the API request for the network ID and by embedding/injecting the source IP into the request packet/API header at 376, as described above. The virtual connection point 340 can then make an API call to the ID provider 342 to determine the network ID corresponding to the source IP by parsing the database at 356 and return the network ID, first to the virtual connection point 340 (358) and then as a response to the original HTTP/API call at 360, as described above.

As such, by omitting the redirection of the user equipment 302 (e.g., 370-376 of FIG. 3b) under IPv6 protocol, latency and processing speed can be improved. Accordingly, at least some embodiments of the present disclosure can include determining the connection protocol of the user equipment 302 based on the request, for example, using the ID finder 306 or the API services 308, depending on the routing of the request.

Table 9 below shows examples of the standard latencies for API requests to an embodiment of the disclosed system and Tables 10 and 11 below shows examples of latencies for API requests for network ID to the same system, where latency is shown in ms. Note that for Table 10, the network ID does not yet exist and must be generated. As shown in Tables 9 to 11, the network latency (inherent) accounts for the majority of the latency in the request and that the request for the network ID does not significantly impact the latencies.

TABLE 9
Latency breakdown of standard API requests

| Latency Breakdown | api.smart-id.ca | pub.smart-id.ca |
|---|---|---|
| A: Overall latency (network + | 50-60 | 50-70 |
| application) | | |
| B: application latency (API | 10-30 | 15-20 |
| service on GCP) | | |
| C: network latency | ~50% | >50% |

TABLE 10
Latency breakdown of API requests for network ID (no existing ID)

| Label | Description | Latency |
|---|---|---|
| A | Overall latency (network + application) | 100-200 |
| B | ID Finder (application latency + On-Prem to GCP | 70-90 |
| | roundtrip) | |
| C | API service on GCP | 10-20 |
| D | On-Prem to GCP roundtrip [=B − C] (On-Prem Wireline | 20-30 (~25%) |
| | Caniff <−> Cloud Interconnect <−> GCP) [GCP <−> | |
| | Cloud Interconnect <−> On-Prem Wireline Caniff] | |
| E | Network latency (=A − B) [Internet => On-Prem WAF in | ~50% |
| | Caniff => On-Prem Wireline Caniff] | |
| F | Overall network latency (D + E) | >50% |

TABLE 11
Latency breakdown of API requests for network ID (existing ID available)

| Label | Description | Latency (ms) |
|---|---|---|
| A | Overall latency (network + application) | 50-80 |
| B | ID Finder (application latency + On-Prem to GCP | 20-30 |
| | roundtrip) | |
| C | API service on GCP | 10-20 |
| D | On-Prem to GCP roundtrip [=B − C] (On-Prem Wireline | 10 (~50%) |
| | Caniff <−> Cloud Interconnect <−> GCP) [GCP <−> Cloud | |
| | Interconnect <−> On-Prem Wireline Caniff] | |
| E | Network latency (=A − B) | ~50% |
| F | Overall network latency (D + E) | >50% |

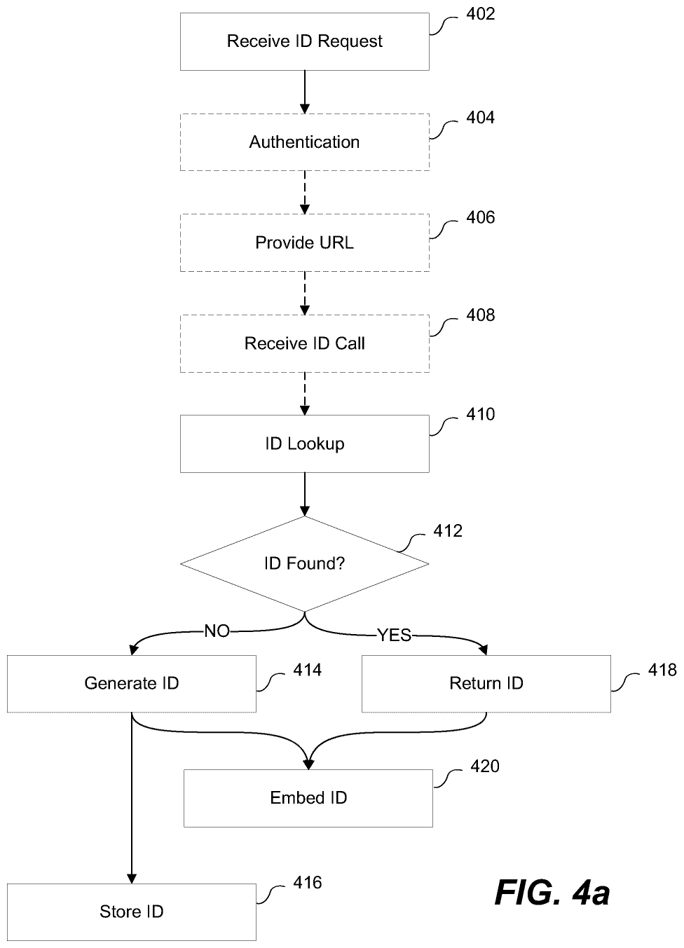

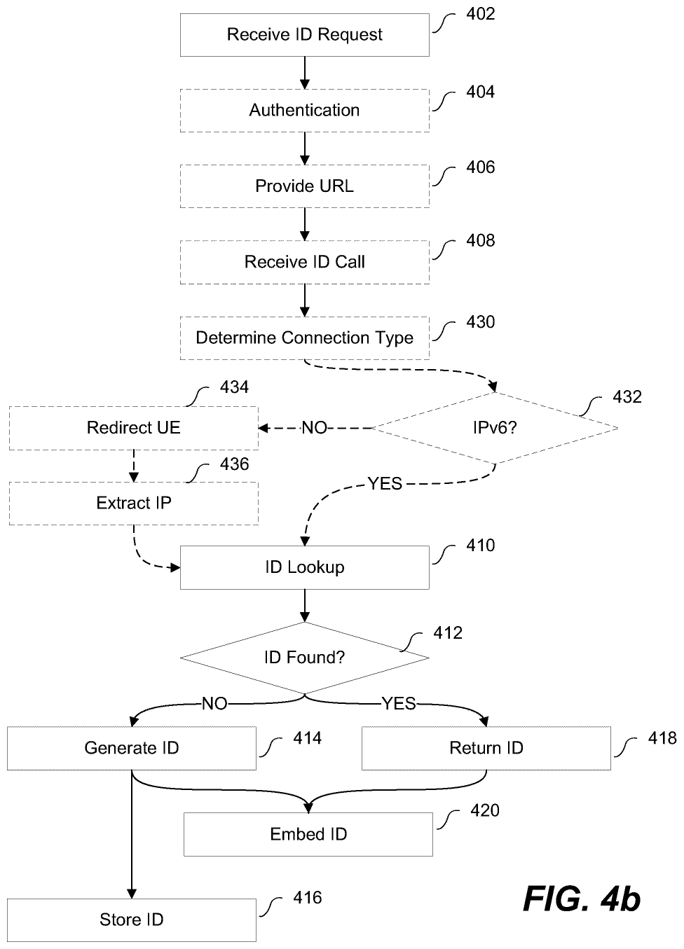

FIG. 4a shows an embodiment of a method for providing a publisher specific network based ID to publishers. As an example, this method may be utilized by a digital identity system configured to provide publisher specific network based IDs (network IDs). The system may be operated by a network provider having access to data pertaining to subscribers of their service such that a source IP may be used to identify particular devices subscribed to the network provider.

At 402, a request for a network ID is received, the network ID being configured to identify a particular user device/equipment. The requested network ID may be a user ID, a household ID, or both, as described above. The request may be received from a publisher that is interested in identifying a user device that has requested access to the content of the publisher. In some embodiments, the request may be in the form of an API call. In some embodiments, the request may additionally/alternatively be for a retrieval URL for directing the user device to acquire the network ID.

According to some embodiments, the request from the publisher may be authenticated at 404. In particular, the request from the publisher may be required to include an access code/token which is unique to the publisher that indicates that the publisher is authorized to request network IDs. The detailed process for authenticating the publisher was described above. The subsequent steps may only be performed if the request is permissible. At 406, a retrieval URL for directing the user device to acquire the network ID may be provided, for example, to the publisher, which may be in the form of an asynchronous HTTP JavaScript call. At 408, a retrieval call for the network ID may be received corresponding to a request for the network ID (e.g., to assign the user device with the network ID). The processing of the request from the publisher can processed at an API services component of a public server system. This retrieval call may be received from the user device and may be communicated using the retrieval URL that was provided. The retrieval call may be made in the form of an asynchronous HTTP JavaScript call. It should be noted that the entity configured to process the retrieval call may not be the same entity that processes the network ID request (e.g., API services). In particular, the retrieval call can be processed by a private ID service that may be hosted privately on a private server system communicatively coupled to the public server system.

At 410, ID lookup may be performed, for example by the API service component of the public service. In particular, the retrieval call may be processed to extract a source IP of the user device. The source IP can then be mapped to a network ID, for example, by relating the source IP to a particular subscriber of the network provider, as described above. Specifically, a database storing a plurality of user device records may be parsed. The user device records may comprise information including device information, source IP, subscriber information, and various network IDs associated with various different publishers. The retrieval call may also include information that identifies the publisher. If a network ID corresponding the provided information (e.g., the source IP and the specific publisher) is not found (NO at 412), a new network ID is generated and associated with the provided information at 414. The generated ID is stored in the database at 416 for future uses (e.g., identification and tracking in the future). Alternatively, if parsing of the database determines that a corresponding network ID exists in the data base (YES at 412), the corresponding network ID is returned at 418.

At 420, the network ID is assigned, for example, to the user device. The network ID may be provided to the user device by the asynchronous HTTP JavaScript call that was made or embedded into content by the publisher that is accessed by the user device. The publisher can access the network ID assigned to the user device and use the network ID to identify and monitor the user device.

FIG. 4b depicts another embodiment of a method of a method for providing a publisher specific network based ID to publishers. The method as depicted in FIG. 4b is substantially analogous to the method depicted in FIG. 4a, where differences between the embodiments are described below.

At 408, the retrieval call for the network ID may be received. The retrieval call may be received at the ID services (e.g., ID finder) of the private server system (and forwarded to the API service) or directly at the API services of the public server system. The ID services or the API services can process the retrieval call corresponding to a request for the network ID at 430 to determine a connection protocol type of the request (e.g., the user device operates under). In particular, by processing the structure, format, or comprised information of the request for the network ID, the ID services or the API services can determine if the connection protocol/type is IPV6 or IPv4. If the connection type is IPV6 (YES at 432), the method proceeds to 410, where the request is forwarded to API services (if not already). The source IP can be directly extracted from the request as described above and used to perform ID lookup (410). If the connection type is IPv4 (NO at 432), a redirection URL or a suitable API call may be embedded/returned to the user device (e.g., by the API service) to direct the user device to provide their source IP at 434. For example, the user device may be directed to (e.g. make an API call to) the ID services using the redirection URL or API call, based on which the source IP of the user device may be extracted (e.g., by the ID service) at 436. The source IP may be used to perform ID lookup at 410 as described above. For example, the source IP may be forwarded as a portion of an API request for the network ID to the API services.

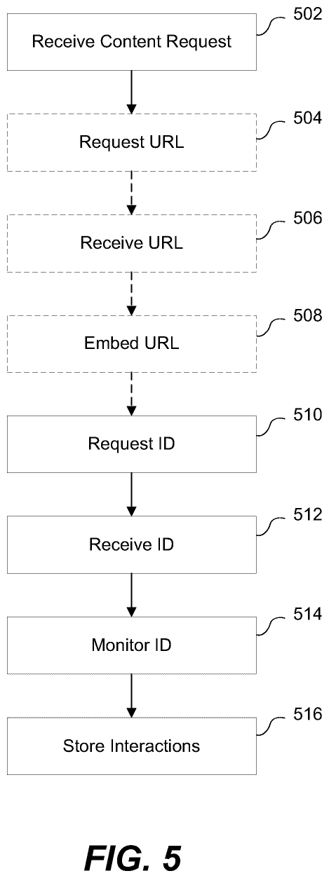

FIG. 5 shows a method of identifying a user using a publisher specific network based ID. As an example, this method may be utilized by a publisher that would like to identify user devices and monitor user device activity in content accessed by the user device using the publisher specific network based IDs (network IDs). The publisher may operate with a digital identity system configured to provide network IDs in order to acquire network IDs for identifying and tracking user devices.

At 502, a request for content may be received, for example, by a publisher from a user device. The content may be a webpage or application operated by the publisher. To identify and monitor the user device, a network ID associated with the user device may be requested at 504. The requested network ID may be a user ID, a household ID, or both, as described above. The network ID may be requested by the publisher where the request may be made to (an API service) of a digital identity system configured to provide network IDs. In some embodiments, the request may be in the form of an API call. In some embodiments, the request may be for a retrieval URL for directing the user device to acquire the network ID. Prior to making the request, the publisher may undergo an authentication process to obtain an access code/token unique to the publisher for authorizing the use of network IDs, as described above. The request may include the public IP of the user device, a unique identifier for identifying the publisher, and the access code/token.

In response to the request, the retrieval URL may be provided, for example, by the digital identity system to the publisher at 506. The retrieval URL may be configured to direct the user device to acquire the network ID and may be in the form of an asynchronous HTTP JavaScript call. The retrieval URL may be provided to the user device at 508. At the same time or prior to providing the retrieval URL, the content requested by the user may be provided to the user. In some embodiments, the retrieval URL is embedded in the content provided by the publisher (e.g., the HTML of the content/webpage). In some embodiments, the publisher may be already in possession of the retrieval URL as they have requested it previously. In such cases, the publisher may provide the retrieval URL to the user device without needing to first request the retrieval URL.

By accessing the content provided by the publisher, the user device is redirected to retrieve the network ID at 510. For example, by accessing the content, the user device may trigger the asynchronous HTTP JavaScript call, which directs the user to communicate with the digital identity system to retrieve the network ID. At 512, the network ID assigned to the user device is accessed. Specifically, the publisher may read the network ID embedded or assigned to the user device. For example, the publisher may trigger a call back URL to acquire the network ID. That is, the user device may make a asynchronous HTTP JavaScript call to the call back URL of the publisher as to provide the network ID.

The user device is identified using the network ID at 514. The publisher may monitor the activities of the user device with regard to the content provided by the publisher. The publisher may identify and monitor data such the accesses to the content, the number/time of accesses, the interactions with the provided content, as well as other metrics and activities of interest associated with the user device using the network ID, for example, with a software development kit. At 516, the data related to the user device and the monitored activities is stored. These data may also be analyzed to predict user trends and to provide user tailored content.

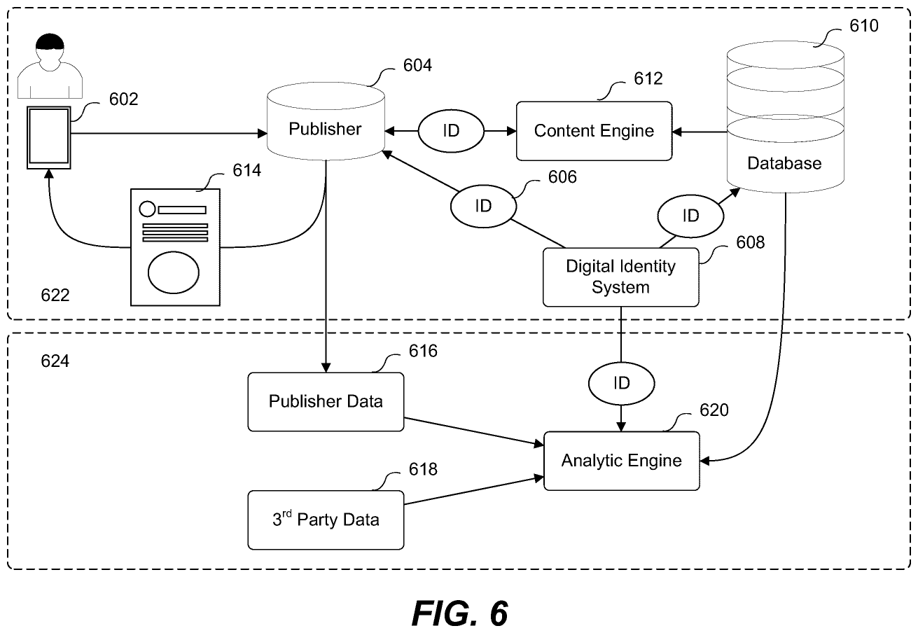

FIG. 6 shows a system for providing personalized content to users using publisher specific network based IDs. As depicted in FIG. 6, a user operating an user device 602 may access content 614 from a publisher 604. The publisher 604 may request a publisher specific network based ID 606 (network ID) for the user device 602 from a digital identity system 608, as described above. The network ID 606 may be provided to a content engine 612 configured to generate tailored content of interest for the user device 602. By tracking the network ID 606 and activities associated therewith, the content engine 612 may be able to better provide tailored content for user operating the user device 602. The personalized content may be integrated with the content 614 that is provided to the user device 612.

The activities and data associated with the user device 602 and/or the network ID 606 may be monitored and stored by the digital identity system 608 in a database 610. The content engine 612 may access the data from the database 610 to analyze trends and behaviours associated with a particular network ID 606 to better provide tailored content of interest. Although the network ID 606 is specific to a particular publisher 604, it may be possible for a particular personalized content provider to request access to a range of network IDs or network IDs associated with a range of publishers as interest may be in order to provide personalized content to a specific audience. The user device 602, publisher 604, digital identity system 608, database 610, and content engine 612 may form a content personalization service system 622.

The publisher may store data associated with the network ID 606 in a publisher data storage 616 configured to store various data associated with activities of user devices based on their network IDs. The data may be stored with data management platform, data management platform, or data lakes, as desired. The publisher data stored in publisher data storage 616, and data stored in the database 610 may be provided to an analytics engine 620. Additionally, the data associated with the network ID 606 may be directly provided to the analytics engine 620. Further, third party data 618 from other sources may also be provided to the analytics engine 620. The analytics engine 620 may be configured to analyze various data to provide insights, trends, and behaviours associated with user devices to be used for personalized content generation. The analyzed insights, trends, and behaviours may be provided to the database 610 for use in providing tailored content to the user device 602. The publisher data storage 616, third party data 618, and analytics engine 620 may form an analytics service system 624.

In some embodiments, the system can provide MMS functionalities. In particular, the MMS functionalities can call the API as a failover solution in case subscriber info cannot be retrieved from the PGW feed (e.g., cache). This redundancy can ensure higher success in delivery of MMS to the subscriber as well as the retrieval of subscriber information. A further implementation of the present disclosure can be for use with e-commerce publishers. In some embodiments, For example, the publisher can use MMS messages to authenticate users and complete transactions. Accordingly, the successful delivery of the MMS message can indicate a correct assignment of the network ID.

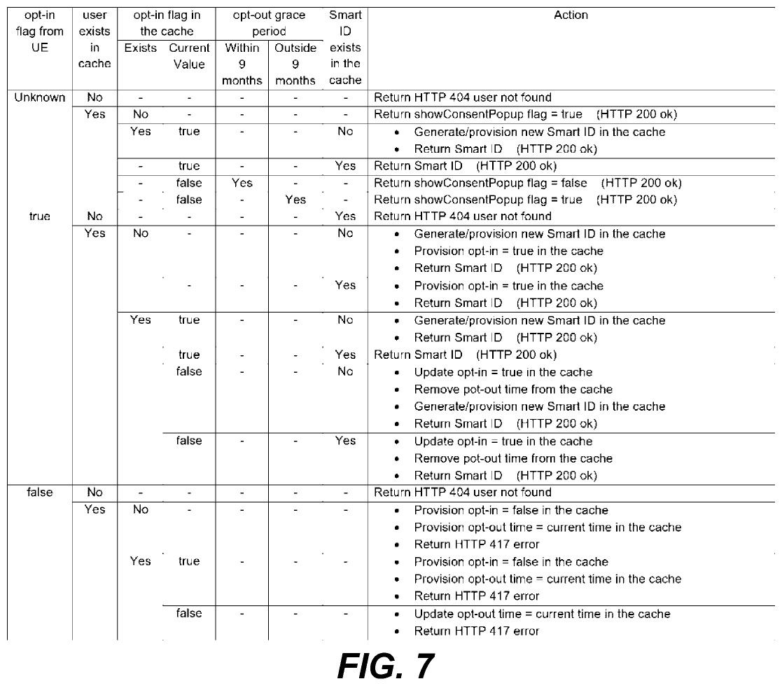

It should be noted that the API services of the digital identity may be configured to provide specific responses to handle the various scenarios based on if the user equipment consents to being tracked using the network ID, as shown in detail in FIG. 7. The range of responses can reduce pop-up fatigue where the publisher needs to ask for consent upon every visit. That is, there may be a grace period (e.g., of 90-days), which can be configurable but common to all publishers or users of the system where the API services suggest to the publisher not to show consent prompts as the opted-out users had expressed opt-out within the grace period of visit. If the user had previously consented, then consent may be assumed to be unchanged until the user intentionally changes their consent through an opt-out page. In particular, the response to a request for network ID may be based on if the user has consented (opt-in flag from UE), which may be true, false, or unknown; if an network ID current exists for the user equipment (user exists in cache), which may be yes or no; if there exists a current consent setting for the user equipment (opt-in flag in the cache), which may be “exists” (yes or no) and the current value if a value exists (“true” for having consented and “false” for not having consented); if opt-out grace period has expired (opt-out grace period); and if a network ID is current stored in the database (Smart ID exists in the cache), which may be yes or no. The response to each scenario is shown in FIG. 7 by way of examples and describes if a network ID (smart ID) is generated and how the each criteria may be updated. As shown in FIG. 7, API services can accommodate in providing or stopping the return of the network ID. Accordingly, the consent status of the UE can be addressed directly using API requests/responses without relying on an external consent management platform.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A method of identifying user devices accessing publishers, comprising:
receiving a request for a unique user identifier associated with a user device that accesses a publisher;
parsing a database for an existing user identifier associated with the user device for the publisher, the database storing a plurality of existing user identifiers associated with user devices for respective publishers;
when the existing user identifier is found, returning the existing user identifier associated with the user device; and
when there is no existing user identifier:
generating the unique user identifier associated with the user device specific to the publisher;
returning the unique user identifier; and
storing the unique user identifier in the database in association with the user device and the publisher.

2. The method of claim 1,
wherein the request for the unique user identifier associated with the user device is received from the user device in response to the user device accessing content of the publisher, and
wherein the publisher directs the user device to transmit the request for the unique user identifier.

3. The method of claim 1,
wherein the request for the unique user identifier is an asynchronous call comprising a unique user device identifier and a unique publisher identifier; and
wherein the unique user identifier is returned to the user device via a response to the asynchronous call.

4. The method of claim 3, further comprising:
authenticating the publisher prior to returning the unique user identifier,
wherein the publisher is authenticated based on the unique publisher identifier.

5. The method of claim 1, wherein the request for the unique user identifier comprises a public IP of the user device.

6. The method of claim 1,
wherein the user device is identified by a source IP associated with a subscriber of a network provider;
wherein the unique user identifier corresponds to the subscriber and is parsed from the database or generated based on subscriber information of the subscriber and/or the source IP.

7. The method of claim 1, further comprising:
determining a connection protocol of the request for the unique user identifier,
wherein the connection protocol is IPv4 or IPv6.

8. The method of claim 7, further comprising,
extracting a source IP of the user device for parsing the database from the request for the unique user identifier,
wherein the request for the unique user identifier is an IPV6 request; and
wherein the source IP corresponds to the unique user identifier.

9. The method of claim 7,
wherein the request for the unique user identifier is an IPV4 request,
the method further comprising:
transmitting instructions for retrieving the unique user identifier to the user device;
receiving a retrieval request corresponding to the instructions for the unique user identifier from the user device; and
performing the parsing of the database based on the retrieval request.

10. The method of claim 9, further comprising:
determining a source IP of the user device from the retrieval request for parsing the database,
wherein the source IP corresponds to the unique user identifier;
wherein the instructions is an asynchronous call comprising a redirection URL, and
wherein the retrieval request is an asynchronous call corresponding to the redirection URL for determining the source IP of the user device.

11. The method of claim 9,
wherein the instructions are transmitted to the user device, and
wherein the retrieval request is received from the user device.

12. The method of claim 1, further comprising:
receiving a request for providing the request for the unique user identifier to the user device in response to the user accessing content of the publisher;
verifying the request for providing the request for the unique user identifier to the user device; and
providing the user device with the request for the unique user identifier to the user device.

13. The method of claims 12,
wherein the request for providing the request for the unique user identifier to the user device is received from the publisher;
wherein the request for the unique user identifier is provided to the user device via the publisher; and
wherein the request for the unique user identifier is received from the user device.

14. The method of claim 1,
wherein requests from the user device are formulated as API requests and responses to the user device are formulated as API responses;
wherein an ID finder module implemented on a private server is configured to process the API requests and API responses and communicate with an API module;
wherein the API module is configured to parse the database and process the API requests and API responses from the ID finder module; and
wherein the database and the API module are implemented on a public server.

15. The method of claim 1, further comprising:
verifying a consent status of the user device for the returning of the unique user identifier;
wherein the returning of the unique identifier is dependent on the consent status.

16. The method of claim 15,
wherein the user device has not yet provided the consent status;
the method further comprising:
prompting the user device to provide the consent status.

17. The method of claim 1, further comprising:
determining a connection type of the user device for accessing the publisher;
wherein the unique user identifier is a set of unique identifiers comprising:
a first identifier corresponding to the user device and the publisher; and
a second identifier corresponding to the connection type of the user device and the publisher; and
wherein the connection type is a mobile network connection or a wireline network connection.

18. A method of monitoring user activity, comprising:
receiving a request from a user device for accessing content of a publisher;
redirecting the user device to retrieve a unique user identifier associated with the user device for the publisher;
receiving the unique user identifier from the user device;
monitoring user interactions by the user device with the publisher content; and
storing the user interactions in association with the user identifier.

19. A system comprising one or more processors configured to perform the method of claim 1.

20. A non-transitory computer-readable medium having computer readable instructions stored thereon, which, when executed by one or more processors, configure the one or more processors to perform a method comprising:
receiving a request for a unique user identifier associated with a user device that accesses a publisher;
parsing a database for an existing user identifier associated with the user device for the publisher, the database storing a plurality of existing user identifiers associated with user devices for respective publishers;
when the existing user identifier is found, returning the existing user identifier associated with the user device; and
when there is no existing user identifier:
generating the unique user identifier associated with the user device specific to the publisher;
returning the unique user identifier; and
storing the unique user identifier in the database in association with the user device and the publisher.
